(19) United States
(12) Patent Application Publication
(10) Pub. No.: US 2026/0352883 A1
(43) Pub. Date: Nov. 5, 2026

(54) ENCODING METHOD, DECODING METHOD, POINT CLOUD ENCODER, POINT CLOUD DECODER, AND STORAGE MEDIUM

(71) Applicant: GUANGDONG OPPO MOBILE TELECOMMUNICATIONS CORP., LTD., Dongguan (CN)

(72) Inventors: Fuzheng YANG, Dongguan (CN); Junyan HUO, Dongguan (CN); Yanzhou MA, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/737,533

(22) Filed: Jul. 10, 2026

Related U.S. Application Data
(63) Continuation of application No. PCT/CN2024/072369, filed on Jan. 15, 2024.

(51) Int. Cl. H04N 19/597; H04N 19/13; H04N 19/169; H04N 19/91; H04N 19/96

(52) U.S. Cl. CPC H04N 19/597; H04N 19/13; H04N 19/1883; H04N 19/91; H04N 19/96

(57) ABSTRACT

The present application discloses an encoding method, a decoding method, a point cloud encoder, a point cloud decoder, and a storage medium. The encoding/decoding method comprises: determining a target context state set on the basis of a local sparse category of a current child node; determining a context state from the target context state set on the basis of context information of the current child node; determining a target entropy encoding/decoding parameter set on the basis of a prediction mode of the current child node; and determining a target entropy encoding/decoding parameter from the target entropy encoding/decoding parameter set on the basis of the context state, and performing entropy encoding/decoding on occupancy information of the current child node.

### CROSS-REFERENCE TO RELATED APPLICATIONS

This application is a continuation of International Application No. PCT/CN2024/072369, filed on Jan. 15, 2024, the disclosure of which is hereby incorporated by reference in its entirety.

### TECHNICAL FIELD

Embodiments of this application relate to the technical field of point cloud encoding and decoding technology, and in particular, to an encoding method, a decoding method, a point cloud encoder, a point cloud decoder, and a storage medium.

### BACKGROUND

Currently, in the Geometry-based Point Cloud Compression (G-PCC) encoding and decoding framework, the geometric information of a point cloud and the attribute information corresponding to points in the point cloud are encoded separately. For the G-PCC encoding and decoding framework, the geometry encoding and decoding technologies can be classified into octree-based geometry encoding and decoding technology, triangle soup (Trisoup)-based geometry encoding and decoding technology, and prediction tree-based geometry encoding and decoding technology.

In the octree-based geometry encoding and decoding technology, when encoding and decoding occupancy information based on the context information of a node to be coded, there are problems of high computational complexity and low encoding and decoding efficiency.

### SUMMARY

The embodiments of this application provide an encoding method, a decoding method, a point cloud encoder, a point cloud decoder, and a storage medium, to reduce the quantity of context states, save a large amount of storage space, reduce the bitrate, and improve encoding and decoding efficiency.

The technical solutions of the embodiments of this application can be implemented as follows.

In a first aspect, an embodiment of this application provides a decoding method, applied to a point cloud decoder, the method comprising:
determining a local sparse category of a current child node according to occupancy information of decoded neighbor nodes of the current child node;
determining a target context state set of the current child node according to the local sparse category, wherein the target context state set comprises one or more context states, each context state corresponding to respective context information;
determining a target context state of the current child node from the target context state set according to the context information of the current child node;
determining a target entropy decoding parameter set of the current child node according to a prediction mode of the current child node;
determining a target entropy decoding parameter of the current child node from the target entropy decoding parameter set according to the target context state;
performing entropy decoding on a bitstream according to the target entropy decoding parameter to determine occupancy information of the current child node.

In a second aspect, an embodiment of this application provides an encoding method, applied to a point cloud encoder, the method comprising:
determining a local sparse category of a current child node according to occupancy information of encoded neighbor nodes of the current child node;
determining a target context state set of the current child node according to the local sparse category, wherein the target context state set comprises one or more context states, each context state corresponding to respective context information;
determining a target context state of the current child node from the target context state set according to context information of the current child node;
determining a target entropy encoding parameter set of the current child node according to a prediction mode of the current child node;
determining a target entropy encoding parameter of the current child node from the target entropy encoding parameter set according to the target context state;
performing entropy encoding on occupancy information of the current child node according to the target entropy encoding parameter, and writing a resulting coded bit into a bitstream.

In a third aspect, an embodiment of this application provides a point cloud encoder, the point cloud encoder comprising a first determining unit, a second determining unit, and an encoding unit; wherein,
the first determining unit is configured to determine a local sparse category of a current child node according to occupancy information of encoded neighbor nodes of the current child node; determine a target context state set of the current child node according to the local sparse category, wherein the target context state set comprises one or more context states, each context state corresponding to respective context information;
the first determining unit is further configured to determine a target context state of the current child node from the target context state set according to context information of the current child node;
the second determining unit is configured to determine a target entropy encoding parameter set of the current child node according to a prediction mode of the current child node; determine a target entropy encoding parameter of the current child node from the target entropy encoding parameter set according to the target context state;
the encoding unit is configured to perform entropy encoding on the occupancy information of the current child node based on the target entropy encoding parameter, and write a resulting coded bit into a bitstream.

In a fourth aspect, an embodiment of this application provides a point cloud encoder, comprising a first memory and a first processor; wherein,
the first memory is configured to store a computer program executable on the first processor;
the first processor is configured to, when executing the computer program, perform the method according to the second aspect.

In a fifth aspect, an embodiment of this application provides a point cloud decoder, the point cloud decoder comprising a third determining unit, a fourth determining unit, and a decoding unit; wherein,
the third determining unit is configured to determine a local sparse category of a current child node according to occupancy information of decoded neighbor nodes of the current child node; determine a target context state set of the current child node according to the local sparse category, wherein the target context state set comprises one or more context states, each context state corresponding to respective context information;
the third determining unit is further configured to determine a target context state of the current child node from the target context state set according to context information of the current child node;
the fourth determining unit is configured to determine a target entropy decoding parameter set of the current child node based on a prediction mode of the current child node; determine a target entropy decoding parameter of the current child node from the target entropy decoding parameter set based on the target context state;
the decoding unit is configured to perform entropy decoding on a bitstream according to the target entropy decoding parameter to determine the occupancy information of the current child node.

In a sixth aspect, an embodiment of this application provides a point cloud decoder, comprising a second memory and a second processor; wherein,
the second memory is configured to store a computer program executable on the second processor;
the second processor is configured to, when executing the computer program, perform the method according to the first aspect.

In a seventh aspect, an embodiment of this application provides a computer-readable storage medium, the computer-readable storage medium storing a bitstream generated by the encoding method as described.

In an eighth aspect, an embodiment of this application provides a computer-readable storage medium, the computer-readable storage medium storing a computer program, the computer program, when executed, implementing the method according to the first aspect, or implementing the method according to the second aspect.

### BRIEF DESCRIPTION OF DRAWINGS

FIG. 1 is a schematic diagram of a network architecture for point cloud encoding and decoding.

FIG. 2 is a schematic diagram of a framework of a G-PCC encoder.

FIG. 3 is a schematic diagram of a framework of a G-PCC decoder.

FIG. 4 is a schematic diagram of an implementation framework of an OBUF technology.

FIG. 5 is a schematic diagram of an application implementation flow of an OBUF technology.

FIG. 6 is a schematic diagram of a priority for dynamically adjusting context.

FIG. 7 is a schematic diagram of a scan order of child nodes in a current node.

FIG. 8 is a schematic flowchart of construction of inter context information.

FIG. 9 is a schematic flowchart of intra/inter entropy encoding based on an OBUF technology.

FIG. 10 is a first schematic flowchart of a decoding method provided by an embodiment of this application.

FIG. 11 is a schematic diagram of a distribution of child neighbor nodes and coplanar parent neighbor nodes of a child node 0.

FIG. 12 is a schematic diagram of a distribution of 20 parent neighbor nodes of a child node 0.

FIG. 13 is a second schematic flowchart of a decoding method provided by an embodiment of this application.

FIG. 14 is a first schematic flowchart of an encoding method provided by an embodiment of this application.

FIG. 15 is a second schematic flowchart of an encoding method provided by an embodiment of this application.

FIG. 16 is a schematic diagram of a structure of a point cloud encoder provided by an embodiment of this application.

FIG. 17 is a schematic diagram of a specific hardware structure of a point cloud encoder provided by an embodiment of this application.

FIG. 18 is a schematic diagram of a structure of a point cloud decoder provided by an embodiment of this application.

FIG. 19 is a schematic diagram of a specific hardware structure of a point cloud decoder provided by an embodiment of this application.

FIG. 20 is a schematic diagram of a structure of an encoding and decoding system provided by an embodiment of this application.

### DESCRIPTION OF EMBODIMENTS

To understand features and technical contents of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following description, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific order of objects. It may be understood that “first/second/third” may be interchanged if allowed, so that the embodiments of this application described herein may be implemented in a sequence other than the sequence illustrated or described herein.

The names and terms used in embodiments of this application are described before providing a more detailed description of embodiments of this application, and the names and terms used in embodiments of this application are applicable to the following explanations:
point cloud compression (Point Cloud Compression, PCC);
geometry-based point cloud compression (Geometry-based Point Cloud Compression, G-PCC or GPCC);
video-based point cloud compression (Video-based Point Cloud Compression, V-PCC or VPCC);
octree (Octree);
triangle soup (Triangle soup, Trisoup);
K nearest neighbor (K Nearest Neighbor, KNN);
level of detail (Level of Detail, LOD);
predicting transform (Predicting Transform);
lifting transform (Lifting Transform);
region adaptive hierarchal transform (Region Adaptive Hierarchal Transform, RAHT); and
context-based adaptive binary arithmetic coding (Context-based Adaptive Binary Arithmetic Coding, CABAC).

A point cloud is a three-dimensional representation of a surface of an object. A point cloud (data) on a surface of an object may be collected by using a collection device such as an optoelectronic radar, a laser radar, a laser scanner, and a multi-angle camera.

The point cloud (Point Cloud) is a set of massive three-dimensional points, and a point in the point cloud may include location information of the point and attribute information of the point. For example, the location information of the point may be three-dimensional coordinate information of the point, and may also be referred to as geometric information of the point. For example, the attribute information of the point may include color information, reflectivity, and/or the like. For example, the color information may be information in any color space. For example, the color information may be RGB information, where R denotes red (Red, R), G denotes green (Green, G), and B denotes blue (Blue, B). For another example, the color information may be information about luminance and chrominance (YCbCr, YUV), where Y denotes luminance, Cb(U) denotes blue chroma, and Cr(V) denotes red chroma.

For a point cloud obtained according to the laser measurement principle, a point in the point cloud may include three-dimensional coordinate information of the point and laser reflectance (reflectance) of the point. For another example, for a point cloud obtained according to the photographing measurement principle, a point in the point cloud may include three-dimensional coordinate information of the point and color information of the point. For another example, for a point cloud obtained with reference to the laser measurement principle and photographing measurement principle, a point in the point cloud may include three-dimensional coordinate information of the point, laser reflectance (reflectance) of the point, and color information of the point.

Point clouds may be classified into the following three types according to acquisition methods.

Type 1: Static point cloud, for which an object is still, and a device for acquiring the point cloud is also still.

Type 2: Dynamic point cloud, for which an object is moving, but a device for acquiring the point cloud is still.

Type 3: Dynamically acquired point cloud, for which a device for acquiring the point cloud is moving.

For example, point clouds are classified into the following two types according to their usage.

Type 1: Machine perception point cloud, which may be used in a scenario such as an autonomous navigation system, a real-time inspection system, a geographic information system, a visual sorting robot, or a disaster relief robot.

Type 2: Human eye perception point cloud, which may be used in a point cloud application scenario such as a digital cultural heritage, free view broadcasting, three-dimensional immersion communication, or three-dimensional immersion interaction.

Since a point cloud is a collection of massive points, storing the point cloud consumes a large amount of memory, and is also not conducive to transmission. In addition, there is no such bandwidth that may support direct transmission of a point cloud without compression at a network layer. Therefore, it is necessary to compress the point cloud.

As of now, a point cloud encoding framework that can compress a point cloud may be a G-PCC coding framework or a V-PCC coding framework provided by a moving picture experts group (Moving Picture Experts Group, MPEG), or an AVS-PCC coding framework provided by an audio video standard (Audio Video Standard, AVS). The G-PCC coding framework may be configured to compress the static point cloud of type 1 and the dynamically acquired point cloud of type 3, and the V-PCC coding framework may be configured to compress the dynamic point cloud of type 2. The G-PCC coding framework is mainly described in embodiments of this application.

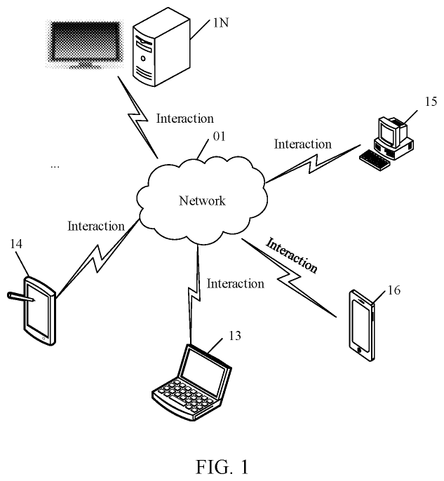

Embodiments of this application provide a network architecture of a point cloud coding system including a decoding method and an encoding method. FIG. 1 is a schematic diagram of a network architecture of point cloud coding according to an embodiment of this application. As shown in FIG. 1, the network architecture includes one or more electronic devices 13 to 1N and a communication network 01. The electronic devices 13 to 1N may perform video interaction with each other through the communication network 01. In an implementation process, the electronic devices may be various types of devices with a coding function. For example, the electronic devices may include a mobile phone, a tablet computer, a personal computer, a personal digital assistant, a navigator, a digital telephone, a video telephone, a television set, a sensing device, and a server. This is not limited in embodiments of this application. The decoder or the encoder in embodiments of this application may be the foregoing electronic device.

The electronic devices in embodiments of this application have a point cloud coding function, and generally include a point cloud encoder (namely, an encoder) and a point cloud decoder (namely, a decoder).

The following describes related technologies by using the G-PCC coding framework as an example.

It may be understood that, in a point cloud G-PCC coding framework, point cloud data to be encoded is first partitioned into a plurality of slices through slicing (slice). In each slice, geometric information and attribute information of the point cloud are separately encoded.

FIG. 2 is a schematic diagram of a framework of a G-PCC encoder. As shown in FIG. 2, in a geometric encoding process, coordinate transform is performed on geometric information, so that the whole point cloud is included in a bounding box (Bounding Box), and then quantization is performed. The quantization in this step mainly plays a role of scaling. Because of rounding operations in the quantization, a part of the point cloud has the same geometric information. Then whether to remove duplicate points is determined based on a parameter. The process of quantization and removal of duplicate points is also referred to as voxelization. Next, octree partition or prediction tree construction is performed on the bounding box. In this process, entropy encoding is performed on points in leaf nodes obtained by partition, to generate a binary geometry bitstream; or entropy encoding (surface fitting based on vertices) is performed on vertices (Vertex) generated by partition to generate a binary geometry bitstream. In an attribute encoding process, geometric encoding is already completed. After the geometric information is reconstructed, color transform is required to be performed first, and color information (namely, attribute information) is transformed from RGB color space to YUV color space. Then, the point cloud is colored again by using the reconstructed geometric information, so that attribute information that is not encoded corresponds to the reconstructed geometric information. The attribute encoding is mainly performed on color information. In a process of encoding the color information, there are mainly two transform methods: one is distance-based lifting transformation depending on LOD partition, and the other is RAHT transformation. Both methods make the color information be transformed from a spatial domain to a frequency domain, obtaining a high-frequency coefficient and a low-frequency coefficient. Finally, the coefficients are quantized to obtain quantized coefficients, and then entropy encoding is performed on the quantized coefficients to generate a binary attribute bitstream.

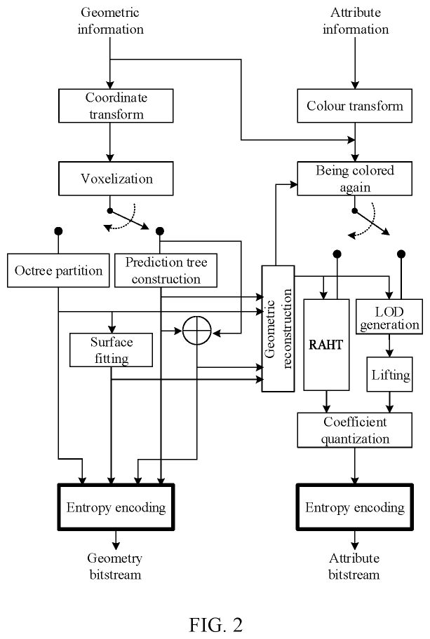

FIG. 3 is a schematic diagram of a framework of a G-PCC decoder. As shown in FIG. 3, for an acquired binary bitstream, a geometric bitstream and an attribute bitstream in the binary bitstream are first separately decoded. To decode the geometry bitstream, entropy decoding is first performed, then one of the following manners is selected: octree partition-surface reconstruction estimation or prediction tree construction, followed by geometric reconstruction-coordinate inverse transformation, and geometric information of a point cloud may be obtained. To decode the attribute bitstream, entropy decoding and dequantization are first performed, then one of the following manners is selected: RAHT transformation or LOD partition-lifting transform, finally color inverse transformation is performed, and the attribute information of the point cloud may be obtained. Data of the point cloud to be encoded can be restored based on the geometric information and the attribute information.

It should be noted that, as shown in FIG. 2 or FIG. 3, currently G-PCC geometry coding may be octree-based geometry coding, Trisoup-based geometry coding, or prediction tree-based geometry coding. Details are as follows.

### (a) Octree-Based Geometry Coding

On an encoding side, coordinate transform is first performed on geometric information, so that the whole point cloud is included in a bounding box (Bounding Box) determined by two extreme points (0, 0, 0) and (2d, 2d, 2d), and then voxelization, namely, quantization, rounding operation, or removal of duplicate points (determined depending on a parameter) is performed. Next, octree partition is continuously performed on sub-cubes that are not empty (including points in the point cloud) in the bounding box in a breadth-first traversal sequence. In a same octree depth, one node is partitioned into eight child nodes and partition is continue to be performed until a leaf node obtained becomes a unit cube of 1×1×1. 8 bits (Bits) binary code generated for determining whether occupancy occurs in a sub-cube (being occupied is represented by 1 and being unoccupied is represented by 0) is called occupancy code (Occupancy Code). Occupancy code of respective nodes is encoded to generate a binary code stream.

On a decoding side, parsing is continuously performed in a breadth-first traversal sequence to obtain occupancy code of respective nodes, and the respective nodes are sequentially partitioned continuously until a unit cube of 1×1×1 is obtained. Then parsing is performed to obtain a quantity of points included in each leaf node, and finally geometric reconstruction point cloud information is obtained.

### (b) Trisoup-Based Geometry Coding

On the encoding side, octree is first partitioned. Different from the octree-based geometry coding, this method does not require partitioning the point cloud into bottom-level leaf nodes with a side length of 1×1×1 step by step, but requires partitioning the point cloud into leaf nodes with a specified side length. Then, surface information formed by voxels in the nodes is represented by a series of triangle meshes (Triangle Mesh). In GPCC, a parameter Trisoup node size may be used to represent a size of a block (Block) in which a triangular mesh is located. When the Trisoup node size is greater than 0, a voxel set in a node is represented by using a geometric mesh, and at most twelve vertices generated by a geometric mesh and twelve edges of the block are referred to as vertices (Vertex). Vertex coordinates of respective blocks are sequentially encoded to generate a binary bitstream.

On the decoding side, to decode geometric coordinates of the point cloud from the triangular mesh of the node, it is necessary to check whether each voxel in the node cube intersects with the triangular mesh. This technique is called triangular rasterization.

### (c) Prediction Tree-Based Geometry Coding

On an encoding side, sorting is performed on an input point cloud. Sorting methods currently used include disordering, Morton ordering, azimuth ordering, and radial distance ordering. On the encoding side, a prediction tree structure is established in two different modes: high-latency slow mode (KD-Tree, KD tree) and low-latency fast mode (assigning the points to different lasers (Laser) by using LiDAR calibration information, and building a predictive tree structure based on different lasers). Next, based on the prediction tree structure, each node in the prediction tree is traversed, geometric location information of the node is predicted by selecting different prediction modes to obtain a prediction residual, and the prediction residual is quantized by using a quantization parameter. Finally, encoding is performed on the prediction residual of location information of the prediction tree node, the prediction tree structure, the quantization parameter, and the like by means of continuous iteration, to generate a binary bitstream.

A prediction tree structure is reconstructed on the decoding side by continuously parsing bitstreams, then prediction residual information of geometric locations of respective prediction nodes and quantization parameters are obtained through parsing, and dequantization is performed on the prediction residual to obtain reconstructed geometric location information of respective nodes. Finally, geometric reconstruction on the decoding end is completed.

It should be further noted that, in a possible implementation of a related technology, an encoder currently used in G-PCC is a context-based adaptive binary arithmetic coding CABAC. This is a form of entropy encoding widely used in video coding. Similar to conventional arithmetic coding, the CABAC uses a recursive interval partitioning method for coding representation. Because the CABAC is adaptive coding, a probability model is adjusted with occurrence of symbols, so that a statistical characteristic of an information source is fully considered, and coding efficiency is greatly improved. The CABAC encoder may include three parts: binarization, context modeling, and binary arithmetic coding. Details are as follows.
(1) Binarization: Binarization is a process of mapping a given non-binary syntax element into a binary sequence, namely, a bin string (Bin String). If the input syntax element is a binary syntax element, binary processing is omitted, and data is directly transmitted to a next step through a bypass.
(2) Context modeling: The encoder assigns a proper probability model to each input bin based on a value of previously encoded syntax element or bin. This process is the context modeling.
(3) Binary arithmetic coding: There are two coding modes available for selection: regular coding mode and bypass coding mode. In the regular coding mode (Regular Coding Mode), the bin (Bin) of the syntax element is transmitted together with the probability model assigned to the bin to the binary arithmetic encoder for coding and the context model is updated based on the value of the bin. This is the adaptive process in coding. Another mode is the bypass coding mode (Bypass Coding Mode), which does not need to assign a specific probability model for each bin. An input bin is encoded directly by using a simple bypass encoder, which can speed up the entire encoding and decoding process.
   1. Optimal Binarization with Update on the Fly (OBUF) Technique

The OBUF technique quickly and accurately maps a series of discrete states of occupancy information of context nodes to a set of adaptive entropy encoders (i.e., probability models) of a fixed quantity through a Look-Up-Table (LUT). In this way, context information is no longer in one-to-one correspondence with probability models. The probability models of the fixed quantity are updated with the current encoded syntax element, and the mapping relationship is updated after each encoding is completed.

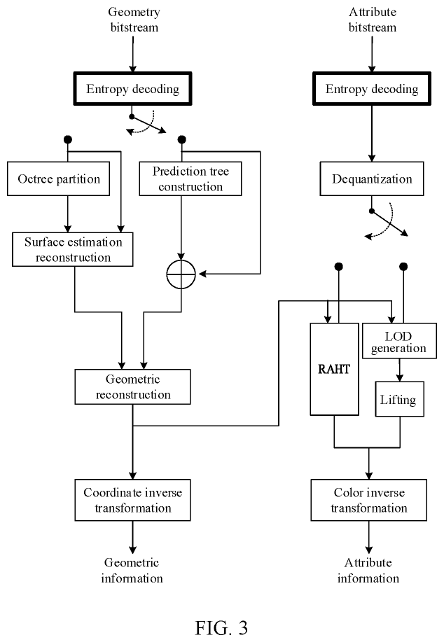

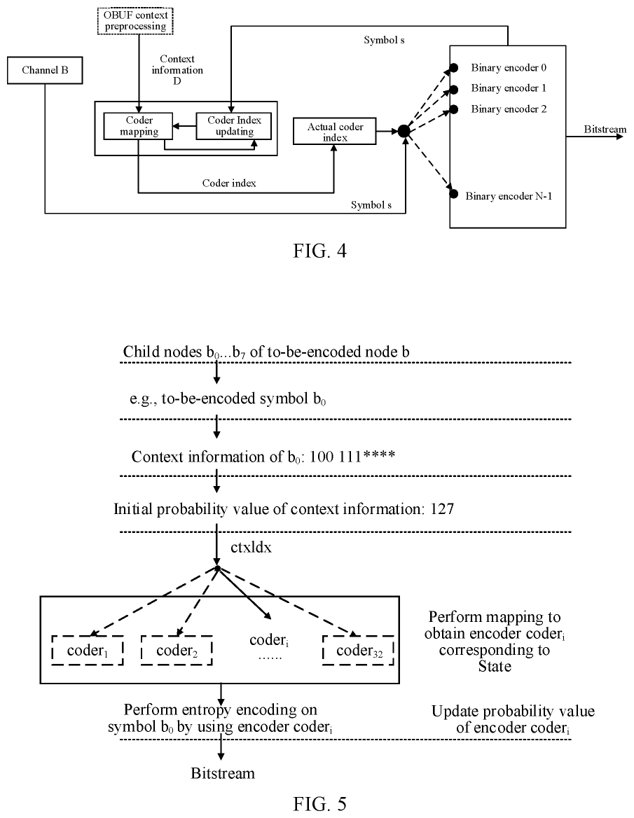

FIG. 4 is a schematic diagram of an implementation flow of an OBUF technique. As shown in FIG. 4, the mapped encoder indices have values of [0, 1, . . . , N−1], and the symbol s is the occupancy bit to be encoded, having a value of 1 or 0.

1) the OBUF Technique can be Divided into the Following Three Steps:

### (1) Obtain the Context Information D of the Symbol to be Encoded

The context information D of the symbol to be encoded is the input information of OBUF, consisting of the information of already encoded neighbor nodes in space and the position of the child node relative to the parent node.

### (2) Obtain the Binary Encoder Index i Corresponding to the Context Information D Based on the Mapping Relationship

Before encoding all symbols to be encoded, each state is mapped to N encoders via a table lookup. For example, each context information D is mapped to one of 32 encoders (i.e., i takes a value of [0, 1, . . . , N−1]), such as the binary entropy encoder i in FIG. 4.

### (3) Use the Binary Encoder i to Perform Entropy Encoding on the Symbol S

The symbol S to be encoded is sent to the binary encoder corresponding to its context information D for entropy encoding.

### 2) Application Example of the OBUF Technique

As shown in FIG. 5, assuming encoding the occupancy status b0 of child node 0 among the eight child nodes of the current node, where b0 has a value of 0 or 1, 0 indicates unoccupied, and 1 indicates occupied. First, the context information of the child node b0 to be encoded is determined, i.e., the occupancy status of the already encoded nodes. This consists of the already encoded neighbor nodes, parent node and closing nodes of the child node to be encoded. These nodes are called context nodes. Each context node has two states: occupied and unoccupied. The occupancy states of all context nodes constitute the context information. The initial probability value of the child node to be encoded being occupied or unoccupied corresponding to the current context information is obtained. Then, based on the mapping relationship, the binary encoder coderi corresponding to the initial probability value is obtained. Finally, the binary encoder coderi is used to perform entropy encoding on the symbol b0 to be encoded.

### 2. Dynamic OBUF Technique

Compared to the OBUF technique, the dynamic OBUF technique no longer uses a fixed quantity of contexts during the encoding process but dynamically adjusts the quantity of contexts.

The dynamic OBUF technique has two stages: 1) dynamically determining context nodes and context information; 2) mapping the context information to a smaller group of binary encoders (compared with the OBUF technique).

The context construction and dynamic adjustment are introduced below. In the dynamic OBUF technique, context information is divided into two parts: primary information and secondary information. Part of the secondary information is dynamically adjusted as context information, the context information composed of the primary information and the selected secondary information is used as the context information of OBUF.

### 1) Context Information Construction Process:

The context nodes of the child node to be encoded include the following categories:
(1) Already encoded sibling nodes;
(2) 6 coplanar parent neighbor nodes of the current node;
(3) Other 20 co-edge or co-point parent neighbor nodes of the current node.

It should be noted that the scan order of these context nodes in sequence is: already encoded sibling nodes of the current child node>already encoded coplanar child node neighbors of the current child node>already encoded co-edge child node neighbors of the current child node>already encoded co-point child node neighbors of the current child node>already encoded other child node neighbors of the current child node>already encoded coplanar parent node neighbors of the current child node>already encoded co-edge parent node neighbors of the current child node>other already encoded 20 parent node neighbors. According to the scan order, context information is constructed for the child node to be encoded. The first N bits of the context information are primary information, and the last M bits are secondary information. M is dynamically adjusted during the encoding process.

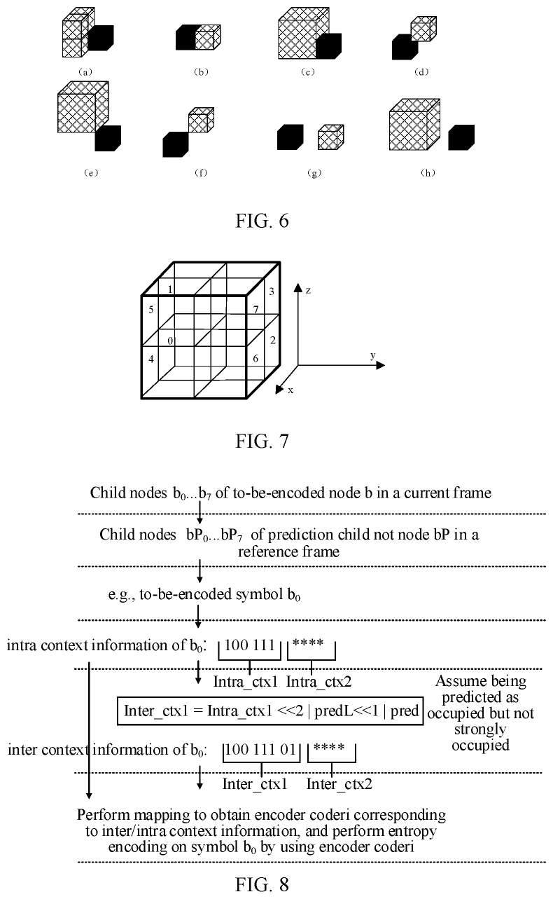

FIG. 6 is a schematic diagram of a priority for dynamically adjusting context. As shown in FIG. 6, a black-filled child node is a current child node, and eight cases are provided herein. In part (a), a grid-filled child node is a sibling child node of the current child node; in part (b), a grid-filled child node is a coplanar neighbor child node of the current child node; in part (c), a grid-filled child node is a coplanar neighbor parent node of the current child node; in part (b), a grid-filled child node is a co-edge neighbor child node of the current child node; in part (e), a grid-filled child node is an adjacent neighbor parent node of the current child node; in part (f), a grid-filled child node is a co-point neighbor child node of the current child node; in part (g), a grid-filled child node is a non-adjacent neighbor child node of the current child node; in part (h), a grid-filled child node is a non-adjacent neighbor parent node of the current child node.

It should be further noted that, during construction of context information, different context models may be first constructed for to-be-encoded child nodes, located at different locations, of the current node according to a preset scanning order. For example, FIG. 7 is a schematic diagram of a scanning order of child nodes in a current node. The scanning order is an order of child node 0, child node 1, child node 2, child node 3, child node 4, child node 5, child node 6, and child node 7 in FIG. 7, which is used to sequentially construct different context models. In addition, as a quantity of encoded child nodes in the current node increases, valid context information that can be referenced by a non-encoded child node also changes. Moreover, there are different modes for determining local sparsity of the eight child nodes of the current node, so that each child node has its own context bin.

### 2) Dynamic Adjustment Process

Each context node can be unoccupied or occupied, i.e., a state of 0 or 1. Context information can be represented by N+M binary bits, including N pieces of primary information and M pieces of secondary information. During the encoding process, the usage count of each piece of context information is recorded. When the usage count of a certain piece of context information exceeds a threshold T, one context node is added according to the scan order, i.e., the context information is refined by introducing a new context node. Subsequent child nodes to be encoded use the updated context information set for encoding.

### 3. G-PCC Dense Point Cloud Inter Coding

### 1) Octree-Based Geometry Encoding

In G-PCC, both intra and inter encoding of octree geometric information use the OBUF technique for entropy encoding. However, the context construction method for inter encoding differs from that for intra encoding. Specifically, the inter context information (Inter State) is actually a combination of the intra context information (Intra State) of the current symbol to be encoded and the prediction information of the current node to be encoded obtained from a reference frame. The specific method is to add information of whether the current node is occupied and whether it is strongly occupied obtained from the reference frame to the intra context information. For example, it is added to the primary intra context information (Intra_ctx1), i.e., Inter_ctx1=Intra_ctx1<<2|predL<<1| pred. Here, predL indicates whether the current child node is predicted to be strongly occupied, and pred indicates whether the current child node is predicted to be occupied. FIG. 8 is a schematic diagram of a construction flow of inter context information.

### 2. Octree Geometry Encoding Based on Inter Prediction

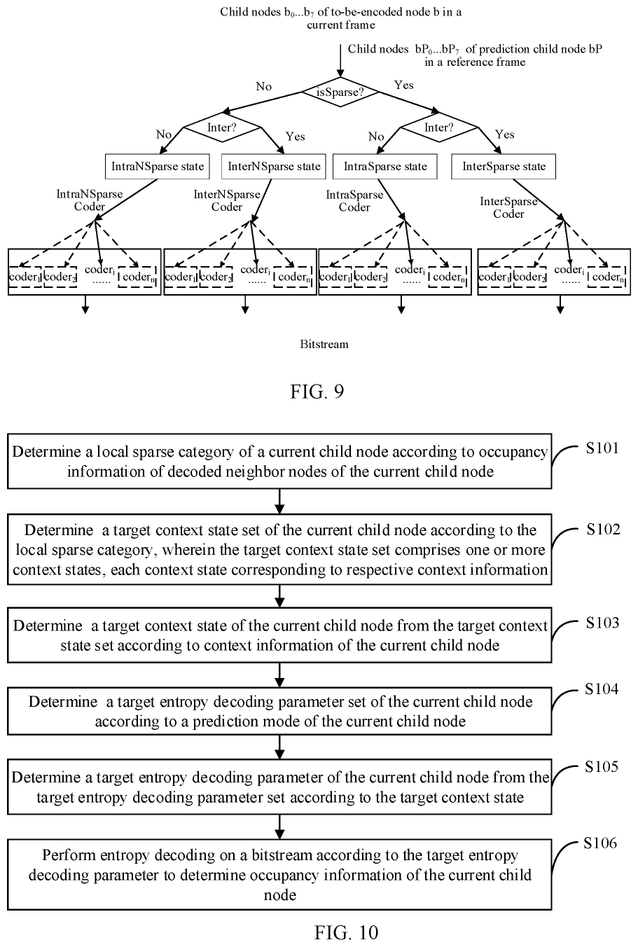

FIG. 9 is a schematic diagram of a flow of intra and inter entropy encoding based on the OBUF technique. First, the value of isSparse is determined based on the intra context information (Intra state) of the child node to be encoded. Here, “isSparse” refers to the local sparsity of the child node to be encoded, which is determined by the occupancy status of the already encoded neighbor nodes of the child node to be encoded. According to the value of isSparse (0 or 1), it is divided into two major sets: a sparse context state set and a non-sparse context state set.

Secondly, the value of isInter2 is determined by the inter enable flag and the occupancy status of the prediction node. According to the value of isInter2 (0 or 1), it is further divided into an intra context state set and an inter context state set. That is, according to the value of isSparse and the value of isInter2, the context states are divided into 4 sets, including an intra non-sparse context state set (IntraNSparse state), an inter non-sparse context state set (InterNSparse state), an intra sparse context state set (IntraSparse state), and an inter sparse context set (InterSparse state).

Then, according to the encoder groups corresponding to each set (IntraNSparse Coder, InterNSparse Coder, IntraSparse Coder, InterSparse Coder), the current context state is mapped to a binary encoder. Finally, based on the mapping, the encoder coderi is obtained to perform entropy encoding on the symbol b0 to be encoded.

In the above technique, the inter sparse context and the inter non-sparse context use their respective encoder groups for entropy encoding. The number of inter context states is 4 times the number of intra context states, requiring a large amount of storage space, which may affect encoding efficiency.

Based on this, an embodiment of this application provides an encoding and decoding method. Different prediction modes can share a context state set. A target context state set is selected only according to different local coefficient categories, reducing the number of context states and saving a large amount of storage space. Further, the context states with a larger quantity in the target context state set are mapped to a smaller number of entropy encoding/decoding parameters in a target entropy encoding/decoding parameter set, reducing the bitrate and improving encoding and decoding efficiency.

To facilitate understanding of the technical solutions of the embodiments of this application, the technical solutions of this application are described in detail below through specific embodiments. The above related technologies can be arbitrarily combined with the technical solutions of the embodiments of this application as optional solutions, and all fall within the protection scope of the embodiments of this application. The embodiments of this application include at least part of the following content.

In one embodiment of this application, referring to FIG. 10, which shows a schematic flowchart of a decoding method provided by an embodiment of this application. As shown in FIG. 10, the method may include:

S101: Determine a local sparse category of a current child node based on occupancy information of decoded neighbor nodes of the current child node.

It should be noted that the decoding method of the embodiment of this application is applied to a point cloud decoder. That is, the decoding method may specifically refer to a point cloud decoding method, or a point cloud entropy decoding method. More specifically, the embodiment of this application provides a point cloud decoding method based on context mapping, which reduces the number of context states, saves storage space, and improves decoding efficiency.

It should be noted that the current child node is any child node of a current node to be decoded. As shown in FIG. 7, the current node includes 8 child nodes, and the scan order of the child nodes is child node 0, child node 1, child node 2, child node 3, child node 4, child node 5, child node 6, and child node 7.

The local sparse category is used to indicate the local sparsity of the decoded neighbor nodes of the current child node. The local sparse category may include one or more sparse categories and one or more non-sparse categories. In some embodiments, determining the local sparse category of the current child node based on the occupancy information of the decoded neighbor nodes of the current child node includes: determining an occupancy count of the neighbor nodes based on the occupancy information of the neighbor nodes; determining the local sparse category of the current child node based on the occupancy count of the neighbor nodes. That is, based on the occupancy information of the neighbor nodes (i.e., whether they are occupied), the occupancy count of the neighbor nodes (i.e., the number NN of occupied neighbor nodes) can be determined, and different local sparse categories are distinguished based on the occupancy count.

Exemplarily, if the occupancy count of the neighbor nodes is greater than a second threshold, the local sparse category of the current child node is determined to be a first category; if the occupancy count of the neighbor nodes is less than or equal to the second threshold, the local sparse category of the current child node is determined to be a second category. Exemplarily, the first category may be a non-sparse category, and the second category may be a sparse category. In practical applications, more local sparse categories may also be included.

In the embodiment of this application, the local sparsity of the current child node is determined by considering the occupancy information of decoded neighbor nodes and the position of the child node relative to a parent node. Exemplarily, the neighbor nodes include at least one of the following: decoded sibling nodes of the current child node; decoded neighbor child nodes adjacent to the current child node in a first preset direction; decoded neighbor child nodes adjacent to the current child node in a second preset direction; or decoded neighbor child nodes adjacent to the current child node in a third preset direction. The first preset direction may refer to the negative x-axis direction (Left direction) of the current child node, the second preset direction may refer to the negative y-axis direction (Front direction) of the current child node, and the third preset direction may refer to the negative z-axis direction (Bottom direction) of the current child node. That is, the local sparse category can be established based on the occupancy count of decoded neighbor nodes adjacent to the current child node in the negative x, y, z directions. It should be noted that the decoded neighbor nodes of the current child node are the same as or not completely the same as the context nodes of the current node.

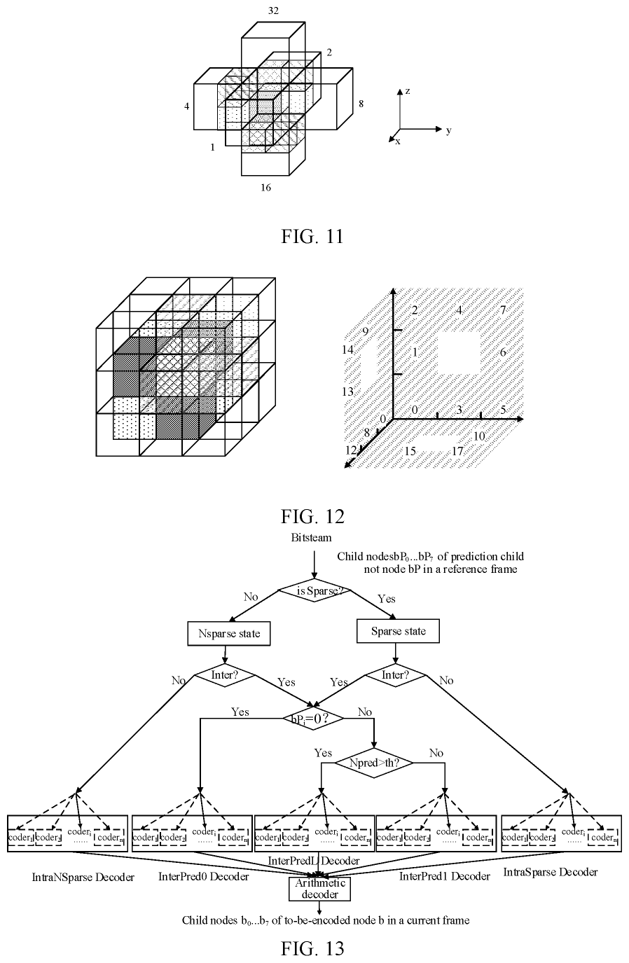

Exemplarily, the local sparse category is represented as isSparse, and different values of isSparse represent different local sparse categories. The value of isSparse for the child node to be decoded is determined based on the occupancy status of the decoded neighbor nodes. Exemplarily, for the local sparse category of child node 0, it can be established based on the occupancy count (NN) of the 12 decoded child nodes adjacent to the current child node in the negative x, y, z directions as shown in FIG. 11. If the occupancy count NN>1, it is non-sparse (isSparse is 0); if the occupancy count NN<=1, it is sparse (isSparse is 1). For the local sparse category of child node 1, it can be established based on the occupancy count (NN) of the 4 decoded child nodes adjacent to the current child node in the negative y direction (Front) as shown in FIG. 11. If the occupancy count NN>0, it is determined to be a non-sparse category; if the occupancy count NN=0, it is determined to be a sparse category. For the local sparse category of child node 2, it can be established based on the occupancy count (NN) of the 4 decoded child nodes adjacent to the current child node in the negative z direction (Bottom) as shown in FIG. 11. If the occupancy count NN>0, it is determined to be a non-sparse category; if the occupancy count NN=0, it is determined to be a sparse category. For the local sparse category of child node 3, NN may be determined based on the 3 nodes bit0+bit1+bit2 together with the 4 decoded nodes adjacent to the current child node in the negative x direction (Left) as shown in FIG. 11, totaling 7 nodes. If the occupancy count NN>1, it is determined to be a non-sparse category; if the occupancy count NN<=1, it is determined to be a sparse category.

S102: Determine a target context state set of the current child node based on the local sparse category, where the target context state set includes one or more context states, and each context state corresponds to respective context information.

It should be noted that different local sparse categories correspond to different context state sets. Corresponding context state sets can be pre-configured for different local sparse categories, and then the target context state set of the current child node is determined based on the local sparse category of the current child node.

Exemplarily, when the local sparse category is a first category, the target context state set is determined to be a first context state set; when the local sparse category is a second category, the target context state set is determined to be a second context state set. In practical applications, more context state sets may also be included. The first context state set includes one or more context states of the first category, each context state corresponding to respective context information of the first category; the second context state set includes one or more context states of the second category, each context state corresponding to respective context information of the second category.

It should also be noted that context states and context information are in one-to-one correspondence. A context state set may include a correspondence between context information and context states, or may include a correspondence between identification information of context information and context states. The context information serves as index information in the context state set to index the corresponding context state. The context information is used to characterize the occupancy status of context nodes of the child node to be decoded, and may also be referred to as the context of the child node to be decoded. The context state is used to represent a first probability that the child node to be decoded is occupied or unoccupied under a certain context information, and may also be referred to as a probability model of the child node to be decoded. Exemplarily, when the bit length of the context information is 19 bits, there are at most 2¹⁹ context states; when the bit length of the context information is 16 bits, there are at most 2¹⁶ context states.

In the embodiment of this application, there is no need to set different context state sets for different prediction modes. Different prediction modes can share a context state set, and the target context state set is selected only based on the local sparse category. As shown in FIG. 9, compared to the prior art which divides context states into 4 sets, including an intra non-sparse context state set (IntraNSparse state), an inter non-sparse context state set (InterNSparse state), an intra sparse context state set (IntraSparse state), and an inter sparse context set (InterSparse state), the embodiment of this application only needs to divide context states into 2 sets, including a non-sparse context state set (NSparse state) and a sparse context state set (Sparse state), significantly reducing the number of context states and saving a large amount of storage space. Additionally, in the embodiment of this application, the construction method for inter context information is exactly the same as that for intra context information, without using inter prediction information for context information construction, which also reduces the number of context states.

In some embodiments, the method further includes: constructing multiple types of context information in the context state set based on occupancy information of context nodes and a first construction strategy, and initializing a context state for each type of context information. Specifically, multiple types of context information in the first context state set are constructed based on occupancy information of context nodes of the first category and the first construction strategy; multiple types of context information in the second context state set are constructed based on occupancy information of context nodes of the second category and the first construction strategy.

S103: Determine a target context state of the current child node from the target context state set based on context information of the current child node.

The context information of the current child node is used to represent the occupancy status of context nodes of the current child node. The context state is a probability that the current child node being occupied or unoccupied under the current context information. The target context state set records a context state corresponding to one or more types of context information. The context state of the current child node is determined by searching the target context state set using the context information of the current child node.

In some embodiments, the method further includes: determining the context information of the current child node based on occupancy information of decoded context nodes of the current child node.

Exemplarily, the context nodes include at least one of the following: decoded sibling nodes of the current child node; decoded neighbor child nodes that are coplanar, co-edge, or co-vertex with the current child node; decoded neighbor parent nodes that are coplanar or co-edge with the current child node; other decoded neighbor nodes of the current child node. The scan order of context nodes may be: decoded sibling nodes of the current child node>decoded coplanar child node neighbors of the current child node>decoded co-edge child node neighbors of the current child node>decoded co-vertex child node neighbors of the current child node>other decoded child node neighbors of the current child node>decoded coplanar parent node neighbors of the current child node>decoded co-edge parent node neighbors of the current child node>other decoded 20 parent node neighbors. Context information is constructed for the child node to be decoded based on the scan order and occupancy information.

Exemplarily, the context information of the current child node is determined based on occupancy information of decoded context nodes of the current child node and the first construction strategy.

The first construction strategy is used to indicate how to generate context information based on the occupancy information of context nodes. The first construction strategy may include: constructing context information based on a preset scan order of the context nodes and the occupancy information of the context nodes; or, constructing first information and second information of the context information based on a preset composition structure of the context information and the occupancy information of the context nodes; the bit length of the first information is fixed, and the bit length of the second information is adjustable. The first information may be primary information, and the second information may be secondary information. Whether part of the information in the secondary information is used as context information is dynamically adjusted.

S104: Determine a target entropy decoding parameter set of the current child node based on a prediction mode of the current child node.

In the embodiment of this application, the prediction mode includes an intra prediction mode and an inter prediction mode. Different prediction modes correspond to different entropy decoding parameter sets. The intra prediction mode corresponds to one or more intra entropy decoding parameter sets, while the inter prediction mode corresponds to one or more inter entropy decoding parameter sets.

The target entropy decoding parameter set includes multiple entropy decoding parameters. An entropy decoding parameter is a parameter used when performing entropy decoding on occupancy information of a child node. In some embodiments, the entropy decoding parameter may be an arithmetic decoding parameter, and adaptive arithmetic decoding is performed on the occupancy information of the child node based on the arithmetic decoding parameter. Exemplarily, the arithmetic decoding parameter may be a probability that the current child node is occupied or unoccupied under the current context information.

In some embodiments, a method for determining the prediction mode of the current child node may include: determining whether the current node is allowed to use the inter prediction mode based on a value of a first syntax element; when the current node is allowed to use the inter prediction mode, determining occupancy information of a prediction node of the current node in a reference frame; determining whether the inter prediction mode is used for a child node of the current node based on the occupancy information of the prediction node, where the current child node is any child node in the current node.

Whether the inter prediction mode is used for the current child node is related to the value of the first syntax element and the occupancy information of the prediction node of the current node (the parent node of the current child node). The first syntax element serves as an enable flag for inter prediction, indicating whether upper-layer inter prediction is enabled. In some embodiments, when the value of the first syntax element is a first numerical value, it is determined that the current node is allowed to use the inter prediction mode; when the value of the first syntax element is a second numerical value, it is determined that the current node is not allowed to use the inter prediction mode. Exemplarily, the first syntax element identifier includes at least a frame-level syntax element. When the value of the first syntax element is 1, inter prediction is allowed to be used; when the value of the first syntax element is 0, inter prediction is not allowed to be used.

Exemplarily, a value of 0 for occupancy information indicates unoccupied, and a value of 1 indicates occupied. That is, when the prediction node is occupied, inter prediction is used for the current node, fully utilizing inter prediction information to improve prediction accuracy; otherwise, inter prediction is not used.

The occupancy status of the prediction node is related to the occupancy status of its child nodes. In some embodiments, the method further includes: determining occupancy information of multiple prediction child nodes in the prediction node; when the occupancy information of at least one prediction child node in the prediction node indicates occupied, determining that the occupancy information of the prediction node indicates occupied; otherwise, determining that the occupancy information of the prediction node indicates unoccupied. That is, if at least one child node in the prediction node is occupied, the value of its occupancy information is set to 1; otherwise, if no child node is occupied, the value of its occupancy information is set to 0.

In some embodiments, determining the target entropy decoding parameter set of the current child node based on the prediction mode of the current child node includes: when the inter prediction mode is used for the current child node, determining the target entropy decoding parameter set from candidate inter entropy decoding parameter sets, where the candidate inter entropy decoding parameter sets include one or more inter entropy decoding parameter sets; when the intra prediction mode is used for the current child node, determining the target entropy decoding parameter set from candidate intra entropy decoding parameter sets, where the candidate intra entropy decoding parameter sets include one or more intra entropy decoding parameter sets. That is, one or more entropy decoding parameter sets can be pre-configured for different inter prediction situations. When the inter prediction mode is used, a matching target entropy decoding parameter set is selected based on the actual inter prediction situation to improve the accuracy of intra prediction. Similarly, one or more entropy decoding parameter sets can be pre-configured for different intra prediction situations. When the intra prediction mode is used, a matching target entropy decoding parameter set is selected based on the actual intra prediction situation to improve the accuracy of intra prediction.

In some embodiments, determining the target entropy decoding parameter set from the candidate inter entropy decoding parameter sets includes: determining the target entropy decoding parameter set from the candidate inter entropy decoding parameter sets based on occupancy information of a prediction child node of the current child node in the reference frame.

The prediction child node is a co-located child node of the current child node in the prediction node. The prediction node is a prediction node of the current node in the reference frame. Prediction information of the current node is determined based on the occupancy information of the prediction node. The prediction node includes multiple prediction child nodes. Further, prediction information of the current child node can be determined based on the occupancy information of the co-located prediction child node of the current child node. Occupancy information is also referred to as bit occupancy information or bit occupancy symbol. The value of occupancy information is 0 or 1, where 0 indicates unoccupied and 1 indicates occupied.

Exemplarily, determining the target entropy decoding parameter set from the candidate inter entropy decoding parameter sets based on the occupancy information of the prediction child node of the current child node in the reference frame includes: when the occupancy information of the prediction child node indicates unoccupied, determining the target entropy decoding parameter set to be a first inter entropy decoding parameter set; when the occupancy information of the prediction child node indicates occupied, determining the target entropy decoding parameter set based on an occupancy intensity of the prediction child node. The occupancy intensity includes one or more intensities. When the prediction child node is occupied, the entropy decoding parameter set is further determined based on the occupancy intensity.

Exemplarily, determining the target entropy decoding parameter set based on the occupancy intensity of the prediction child node includes: when the occupancy intensity of the prediction child node is a first intensity, determining the target entropy decoding parameter set to be a second inter entropy decoding parameter set; when the occupancy intensity of the prediction child node is a second intensity, determining the target entropy decoding parameter set to be a third inter entropy decoding parameter set.

That is, an entropy decoding parameter set is allocated to the current child node based on the occupancy status of the prediction child node. The first entropy decoding parameter set includes multiple entropy decoding parameters for the current child node used when the prediction child node is unoccupied. The second entropy decoding parameter set includes multiple entropy decoding parameters for the current child node used when the prediction child node is occupied. The third entropy decoding parameter set includes multiple entropy decoding parameters for the current child node used when the prediction child node is strongly occupied. In the embodiment of this application, for inter prediction, the entropy decoding parameter set is selected based on whether the current child node is predicted to be unoccupied, occupied, or strongly occupied, fully utilizing the correlation between inter sparse context states and non-sparse context states to improve inter prediction accuracy.

Exemplarily, the occupancy intensity of the prediction child node is related to the quantity of occupied nodes in the prediction child node. Exemplarily, when the quantity of occupied nodes in the prediction child node is greater than a first threshold, the occupancy intensity is determined to be strong occupancy (i.e., the first intensity); when the number of occupied nodes within the prediction child node is less than or equal to the first threshold, the occupancy intensity is determined to be occupancy (i.e., the second intensity).

In other embodiments, determining the target entropy decoding parameter set from the candidate inter entropy decoding parameter sets includes: determining the target entropy decoding parameter set from the candidate inter entropy decoding parameter sets based on the local sparse category.

Exemplarily, when the local sparse category is the first category, the target entropy decoding parameter set is determined as a fourth inter entropy decoding parameter set; when the local sparse category is the second category, the target entropy decoding parameter set is determined as a fifth inter entropy decoding parameter set. That is, when the inter prediction mode is used for the current child node, the inter entropy decoding parameter set may be allocated also according to the local sparse category of the current child node.

Exemplarily, determining the target entropy decoding parameter set from the candidate inter entropy decoding parameter sets may further include: determining the target entropy decoding parameter set corresponding to the target context state set according to a first mapping relationship, where the first mapping relationship includes a mapping relationship between one or more context state sets and inter entropy decoding parameter sets.

In some embodiments, determining the target entropy decoding parameter set from the candidate intra entropy decoding parameter sets includes: determining the target entropy decoding parameter set from the candidate intra entropy decoding parameter sets according to the local sparse category.

Exemplarily, when the local sparse category is a first category, the target entropy decoding parameter set is determined as the first intra entropy decoding parameter set; when the local sparse category is the second category, the target entropy decoding parameter set is determined as the second intra entropy decoding parameter set. That is, when the intra prediction mode is used for the current child node, the intra entropy decoding parameter set is allocated according to the local sparse category of the current child node. The first intra entropy decoding parameter set may include multiple entropy decoding parameters corresponding to the first category, and the second intra entropy decoding parameter set may include multiple entropy decoding parameters corresponding to the second category.

Exemplarily, determining the target entropy decoding parameter set from the candidate intra entropy decoding parameter sets may further include: determining the target entropy decoding parameter set corresponding to the target context state set according to a second mapping relationship, where the second mapping relationship includes a mapping relationship between one or more context state sets and the intra entropy decoding parameter sets.

S105: Determine, according to the target context state, a target entropy decoding parameter of the current child node from the target entropy decoding parameter set;

One or more types of context information correspond to one context state, and the context state is used to index the corresponding target entropy decoding parameter. In some embodiments, determining the target entropy decoding parameter of the current child node from the target entropy decoding parameter set according to the target context state includes: determining an index value of the target entropy decoding parameter according to the target context state and a target mapping relationship; determining the target entropy decoding parameter of the current child node from the target entropy decoding parameter set according to the index value of the target entropy decoding parameter. That is, in the target entropy decoding parameter set, according to a certain mapping rule, the context state is mapped to an index value of a certain entropy decoding parameter to index the target entropy decoding parameter.

It should be noted that the mapping relationships between different context state sets and entropy decoding parameter sets may be the same or different. Exemplarily, the target mapping relationship may include: determining the index value of the target decoder according to the most significant M bits of the context state; where Mis related to the quantity of parameters in the target entropy decoding parameter set. Exemplarily, when the quantity N of parameters in the target entropy decoding parameter set is 32, the most significant 5 bits of the context state are taken, and the value thereof is the index value of the target entropy decoding parameter.

In some embodiments, the entropy decoding parameter may be an arithmetic decoding parameter, and adaptive arithmetic decoding is performed on the occupancy information of the child node according to the arithmetic decoding parameter. Exemplarily, the arithmetic decoding parameter may be the probability that the current child node is occupied or unoccupied under the current context information. Exemplarily, the context state is a first probability that the current child node is occupied or unoccupied under the current context information, which may also be referred to as a first probability model of the child node. The target entropy decoding parameter is a second probability that the current child node is occupied or unoccupied under the current context information, which may also be referred to as a second probability model of the child node. Therefore, the entropy decoding parameter can also be understood as a type of context state, and the entropy decoding parameter set can also be understood as a simplified set of context states.

When the bit length of the context information is 19 bits, there are at most 2¹⁹ context states; when the bit length of the context information is 16 bits, there are at most 2¹⁶ context states. The quantity of parameters in the target entropy decoding parameter set is far less than the quantity of context states. In the embodiment of the present application, the target context state set contains a large number of context states. If these context states are directly used for entropy decoding, the decoding efficiency is low. The target entropy decoding parameter set contains a small number of entropy decoding parameters. The large number of context states in the target context state set is mapped to the small number of entropy decoding parameters in the target entropy decoding parameter set, thereby simplifying the entropy decoding parameters and improving decoding efficiency.

In the embodiment of the present application, the construction method of the inter context information adopts the same construction method as the intra context information. Exemplarily, the construction scheme of the intra context may be as follows.

(1) The child node 0 has a coplanar child node neighbor, a co-edge child node neighbor, and a co-point child node neighbor, and has no decoded sibling node. The child node 0 also has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 16 bits, with a maximum of 2¹⁶ states. The most significant 4 bits are used as primary information and the least significant 12 bits as non-reduced secondary information.

Local sparsity of the child node 0 may be determined based on a number of occupied child nodes (NN) of twelve decoded child nodes adjacent to the current child node in the negative directions of x, y, and z axes in FIG. 11, where the number of occupied child nodes NN>1 indicates being non-sparse, and the number of occupied child nodes NN≤1 indicates being sparse. For example, FIG. 11 is a schematic diagram showing distribution of child neighbor nodes and coplanar parent neighbor nodes of the child node 0, and FIG. 12 is a schematic diagram showing a distribution sequence of 20 parent neighbor nodes of the child node 0. Numbers such as 1, 2, 4, 8, 16, and 32 indicate serial numbers of the neighbor nodes.

Table 1 shows interpretation of context information of each bit corresponding to the child node 0, and an order from the most significant bit to the least significant bit reflects important of information. 1 or 0 filled in bold black blocks represents the flag bit of the current classification. For example, 3 directions indicate that there are occupied context nodes in all of the Left direction, Front direction, and Bottom direction; 2 directions indicate that there are occupied context nodes in the Left direction and Bottom direction, Front direction and Bottom direction, or Left direction and Front direction; 1 direction indicates that there is an occupied context node in the Left direction, Front direction, or Bottom direction. The negation operation “!” indicates that the symbol in the bit is a symbol obtained by negating the actual symbol. In addition, Table 1 also includes coplanar child nodes, co-edge child nodes, co-point child nodes, between-edge child nodes, co-bit child nodes, and the like. In Table 1, meanings of symbols are respectively explained as follows: B (Bottom), F (Front), and L (left) are six-neighbor parent neighbors numbered 16, 4, and 2, respectively, which are coplanar with a current node in FIG. 11. Because the three decoded nodes are located in negative directions of coordinate axes of the current node, occupancy information of child nodes of the three decoded nodes may be obtained. Therefore, Table 1 lists each of coplanar child nodes, co-edge child nodes, and co-point child nodes of the current child node in the three directions. It should be noted that, for example, English abbreviations B, F, and L respectively indicate coplanar child nodes, co-edge child nodes, and co-point child nodes of the current child node, for example, English full names Bottom, Front, and Left respectively indicate co-planar parent neighbors, co-edge parent neighbors, and co-point parent neighbors of the current child node. Top, Back, and Right are six-neighbor parent neighbors numbered 32, 8, and 1, respectively, which are coplanar with the current node in FIG. 11. Because the three decoded nodes are located in positive directions of the coordinate axes of the current node, occupancy information of child nodes of the three decoded nodes cannot be obtained, and correlation of the three decoded nodes is weaker than that of the foregoing 12 neighbor nodes. Other numbers such as 9, 4, 1, and 2 in Table 1 are sequence numbers of 20 co-edge/co-point neighbors of the current node except the six-coplanar parent neighbors shown in FIG. 12. The co-bit child nodes _{bit0}B, _{bit0}F, and _{bit0}L in Table 1 are understood as child nodes whose number is 0 in the decoded Bottom, Front, and Left nodes, which are thus referred to as co-bit child nodes. In Table 1, LF, LB, and FB represented by two letters respectively denote occupancy information (obtained through occupancy code of a neighbor numbered 1 in the 20 neighbors) of two child nodes sharing an edge with the current child node and located between the Left and Front directions, occupancy information (obtained through occupancy code of a neighbor numbered 8 in the 20 neighbors) of two child nodes sharing an edge with the current child node and located between the Left and Bottom directions, and occupancy information (obtained through occupancy code of a neighbor numbered 3 in the 20 neighbors) of two child nodes sharing an edge with the current child node and located between the Front and Bottom directions.

(2) The child node 1 has a coplanar child node neighbor, a co-edge child node neighbor, and a co-point child node neighbor, has one decoded sibling node bit0, and has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 19 bits, with a maximum of 2¹⁹ states. The most significant 7 bits are used as primary information and the least significant 12 bits as non-reduced secondary information.

Local sparsity of the child node 1 may be determined based on a number of occupied child nodes (NN) of four decoded child nodes adjacent to the current child node in the negative direction (Front) of y-axis in FIG. 8, where the number of occupied child nodes NN>0 indicates being non-sparse, and the number of occupied child nodes NN=0 indicates being sparse. Herein, Table 2 shows interpretation of context information of each bit in the bins, and it can be learned that the decoded sibling node 0 occupies most important information and is located at a most significant bit of the bins.

(3) The child node 2 has a coplanar child node neighbor, a co-edge child node neighbor, and a co-point child node neighbor, has two decoded sibling nodes bit0 and bit1, and has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 19 bits, with a maximum of 2¹⁹ states. The most significant 7 bits are used as primary information and the least significant 12 bits as non-reduced secondary information.

Local sparsity of the child node 2 may be determined based on a number of occupied child nodes (NN) of four decoded child nodes adjacent to the current child node in the negative direction (Bottom) of z-axis in FIG. 8, where the number of occupied child nodes NN>0 indicates being non-sparse, and the number of occupied child nodes NN=0 indicates being sparse. Herein, Table 3 shows interpretation of context information of each bit in the bins, and it can be learned that the decoded sibling node 0 occupies most important information and is located at a most significant bit of the bins.

(4) The child node 3 has a coplanar child node neighbor, a co-edge child node neighbor, and a co-point child node neighbor, has three decoded sibling nodes bit0, bit1 and bit2, and has a coplanar parent node neighbor and 20 other decoded neighbors that can be referenced. When it is determined to be non-sparse, the context bins include 17 bits, with a maximum of 2¹⁷ states. The most significant 6 bits are used as primary information and the least significant 11 bits as non-reduced secondary information. When it is determined to be sparse, the context bins include 18 bits, with a maximum of 2¹⁸ states. The most significant 6 bits are used as primary information and the least significant 12 bits as non-reduced secondary information.

Local sparsity of the child node 3 may be determined based on an NN of seven nodes including three nodes bit0+bit1+bit2 and four decoded nodes adjacent to the current child node in the negative direction of x-axis in FIG. 11, where the number of occupied child nodes NN>1 indicates being non-sparse, and the number of occupied child nodes NN≤1 indicates being sparse.

(5) The child node 4 has a coplanar child node neighbor, a co-edge child node neighbor, and a co-point child node neighbor, has four decoded sibling nodes bit0, bit1, bit2 and bit3, and has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 16 bits, with a maximum of 2¹⁶ states. The most significant 4 bits are used as primary information and the least significant 12 bits as non-reduced secondary information.

Local sparsity of the child node 4 may be determined based on an NN of twelve nodes including four nodes bit0+bit1+bit2+bit3 (denoted as “new Left”), four decoded nodes adjacent to the current child node in the negative direction (Front) of y axis, and four decoded nodes adjacent to the current child node in the negative direction (Bottom) of z-axis in FIG. 8, where the number of occupied child nodes NN>1 indicates being non-sparse, and the number of occupied child nodes NN≤1 indicates being sparse.

(5) The child node 5 has a coplanar child node neighbor, a co-edge child node neighbor, and a co-point child node neighbor, has five decoded sibling nodes bit0, bit1, bit2, bit3, and bit4, and has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 19 bits, with a maximum of 2¹⁹ states. The most significant 7 bits are used as primary information and the least significant 12 bits as non-reduced secondary information.

Local sparsity of the child node 5 may be determined based on an NN of child nodes adjacent to the current child node in the negative direction (Front) of y-axis in FIG. 11, where the number of occupied child nodes NN>0 indicates being non-sparse, and the number of occupied child nodes NN=0 indicates being sparse.

(7) The child node 6 has a coplanar child node neighbor, a co-edge child node neighbor, and a co-point child node neighbor, has six decoded sibling nodes bit0, bit1, bit2, bit3, bit4, and bit5, and has a coplanar parent node neighbor and 20 other decoded neighbors that can be referenced. When it is determined to be non-sparse, the context bins include 19 bits, with a maximum of 2¹⁹ states. The most significant 6 bits are used as primary information and the least significant 13 bits as non-reduced secondary information. When it is determined to be sparse, the context bins include 19 bits, with a maximum of 2¹⁹ states. The most significant 7 bits are used as primary information and the least significant 12 bits as non-reduced secondary information.

Local sparsity of the child node 6 may be determined based on an NN of child nodes adjacent to the current child node in the negative direction (Bottom) of z-axis in FIG. 11, where the number of occupied child nodes NN>0 indicates being non-sparse, and the number of occupied child nodes NN=0 indicates being sparse.

(8) The child node 7 has no coplanar child node neighbor, co-edge child node neighbor, or co-point child node neighbor, has seventh decoded sibling nodes bit0, bit0, bit1, bit2, bit3, bit4, bit5, and bit6, and has a coplanar parent node neighbor and 20 other decoded neighbors that can be referenced. When it is determined to be non-sparse, the context bins include 17 bits, with a maximum of 2¹⁷ states. The most significant 6 bits are used as primary information and the least significant 11 bits as non-reduced secondary information. When it is determined to be sparse, the context bins include 18 bits, with a maximum of 2¹⁸ states. The most significant 6 bits are used as primary information and the least significant 12 bits as non-reduced secondary information.

Local sparsity of the child node 7 may be determined based on an NN of seven nodes including bit0+bit1+bit2+bit3+bit4+bit5+bit6, where the number of occupied child nodes NN>1 indicates being non-sparse, and the number of occupied child nodes NN≤1 indicates being sparse.

It should be noted that the 1 or 0 filled in bold black blocks represents the flag bit of the current classification, and each bit can also be assigned a practical meaning. The negation operation on the bit can also be removed.

S106: Perform entropy decoding on the bitstream according to the target entropy decoding parameter to determine the occupancy information of the current child node.

In some embodiments, the method further includes: updating the target entropy decoding parameter and the context state according to the occupancy information of the current child node.

Based on the above embodiments, the decoding method provided by an embodiment of the present application is further illustrated by way of example. As shown in FIG. 13, the decoding method is specifically a decoding method for point cloud geometric information, and the method may include:

### S201: Local Sparsity Determination

The local sparsity (isSparse) of a symbol bn to be decoded is determined according to the occupancy information of the decoded neighbor nodes. For example, for child node 0, the local sparsity is determined according to the occupancy count (NN) of the 12 decoded child nodes adjacent to the current child node in the negative x, y, z directions. If the occupancy count NN>1, it is non-sparse (isSparse is 0); if the occupancy count NN<=1, it is sparse (isSparse is 1).

According to the value of isSparse (0 or 1), the context states can be divided into a sparse context state set and a non-sparse context state set.

### S202: Inter Prediction Determination

Whether to use inter prediction, i.e., the value of isInter2, is determined according to the occupancy information (predOcc) of the prediction node of the current node in the reference frame and the enabling flag (isInter) of inter prediction.

isInter2=isInter&&predOcc, that is, the value of isInter2 is jointly determined by isInter and predOcc, where predOcc is a flag indicating whether a prediction node is occupied. Specifically, if at least one child node bPᵢ in the prediction node is occupied, predOcc is set to 1; otherwise, if no child node is occupied, predOcc is 0. Additionally, the value of isInter is controlled by the syntax element gbh.interPredictionEnabledFlag, which is used to indicate whether upper-layer inter prediction is enabled. If enabled, it is referred to as a P frame, and isInter is 1; otherwise, if not enabled, it is referred to as an I frame, and isInter is 0.

### S203: Context State Selection

First, based on whether it is sparse (isSparse), the context state set to be used is determined. For a non-sparse category, a non-sparse context state set (NSparse state) is used; and for a sparse category, a sparse context state set (Sparse state) is used. Here, the construction method for context information in the non-sparse context state set and the sparse context state set may be the construction method in OBUF or the construction method of dynamic OBUF.

It should be noted that, in the existing construction method of inter context information, 2 bits of inter prediction information are added to intra context information, each type of context information corresponds to one context state, and the quantity of inter context states is four times that of intra context states, requiring a large amount of storage space. In contrast, in the embodiment of this application, construction method for the inter context may adopt the same construction method as that for the intra context, without using inter prediction information for construction, and different prediction modes may share the context state set. The target context state set is selected only based on the local sparse category, reducing the number of context states, saving a large amount of storage space, and improving decoding efficiency.

Secondly, in the selected context state set, based on the context information of the child node to be decoded, the target context state of the child node to be decoded is obtained, that is, the probability P_{S} of the child node to be decoded being occupied (or unoccupied) under this context situation.

### S204: Entropy Decoding Parameter Selection

First, for the intra prediction mode, the entropy decoding parameter set to be used is determined based on the local sparse category, which may also be referred to as a decoder group. Each decoder includes corresponding entropy decoding parameters, and the entropy decoding parameters may also be understood as a type of context state. The context state set includes a larger number of context states, while the decoder group includes a simplified set of context states. Based on the mapping relationship between the context state set and the entropy decoding parameter set, the target entropy decoding parameter set is selected, where the mapping relationship may be one-to-one, one-to-many, or many-to-one.

For the inter prediction mode, the entropy decoding parameter set to be used is determined based on the occupancy information of the prediction child node. The specific method is as shown in FIG. 9.

For the intra prediction mode, if a non-sparse context state set (NSparse state) is used, it is determined to use an intra non-sparse entropy decoding parameter set (IntraNSparse Decoder); if a sparse context state set (Sparse state) is used, it is determined to use an intra sparse entropy decoding parameter set (IntraSparse Decoder).

For the inter prediction mode, if a non-sparse context state (NSparse state) is used and the prediction child node is unoccupied Pred0, it is determined to use an inter entropy decoding parameter set InterPred0 Decoder; for the inter prediction mode, if the prediction child node is occupied Pred1, it is determined to use an inter entropy decoding parameter set InterPred1 Decoder; for the inter prediction mode, if the prediction child node is strongly occupied PredL, it is determined to use an inter entropy decoding parameter set InterPredL Decoder.

For the inter prediction mode, if a sparse context state (Sparse state) is used and the prediction child node is unoccupied Pred0, it is determined to use an inter entropy decoding parameter set InterPred0 Decoder; for the inter prediction mode, if the prediction child node is occupied Pred1, it is determined to use an inter entropy decoding parameter set InterPred1 Decoder; for the inter prediction mode, if the prediction child node is strongly occupied PredL, it is determined to use an inter entropy decoding parameter set InterPredL Decoder.

That is, for the inter prediction mode, the sparse context state and the non-sparse context state share three entropy decoding parameter sets, and the entropy decoding parameter set is selected only based on whether being predicted as unoccupied, occupied, or strongly occupied, fully utilizing the correlation between the inter sparse context state and the inter non-sparse context state, thereby improving inter prediction accuracy.

Specifically, according to the occupancy information of the prediction child node, the information determined as inter prediction (isInter2=1) is classified into the following categories:
a) Pred0: When the prediction child node i is empty, the current child node i is predicted to be unoccupied bPi=0.
b) Pred1: When the prediction child node i is non-empty, the current child node i is predicted to be occupied bPi=1; at this time, it is further divided into two cases based on the occupancy count (Npred) of occupied nodes in the prediction child node i:
i. predL=1: When the prediction child node i is non-empty and the quantity (Npred) of occupied nodes therein exceeds a first threshold th, the current child node i is strongly occupied.
ii. predL=0: When the prediction child node i is non-empty and the quantity (Npred) of occupied nodes therein does not exceed the first threshold th, the child node i is not strongly occupied.

Secondly, in the determined decoder group, the context state PS of bn is mapped to the decoder Ci according to a mapping rule. The mapping rule may be taking the most significant 5 bits of the context state, the value of which is the index value of the mapped decoder, and the probability of the mapped decoder Ci is P_{C}.

### S205: Adaptive Arithmetic Decoding

Using the determined probability P_{C} of the decoder Ci, adaptive arithmetic decoding is performed on the occupancy information bn of the child node to be decoded.

In the decoding method provided in the embodiment of this application, when performing inter prediction, the local sparse and local non-sparse share the decoder groups, fully utilizing the inter prediction information to select the best decoder group for the current child node, and further selecting the best entropy decoder based on the context information for decoding, thereby improving decoding efficiency. Additionally, the inter context information and the intra context information may adopt the same construction method, and the quantity of inter context states is the same as the quantity of intra context states, significantly reducing the number of inter context states and saving storage space.

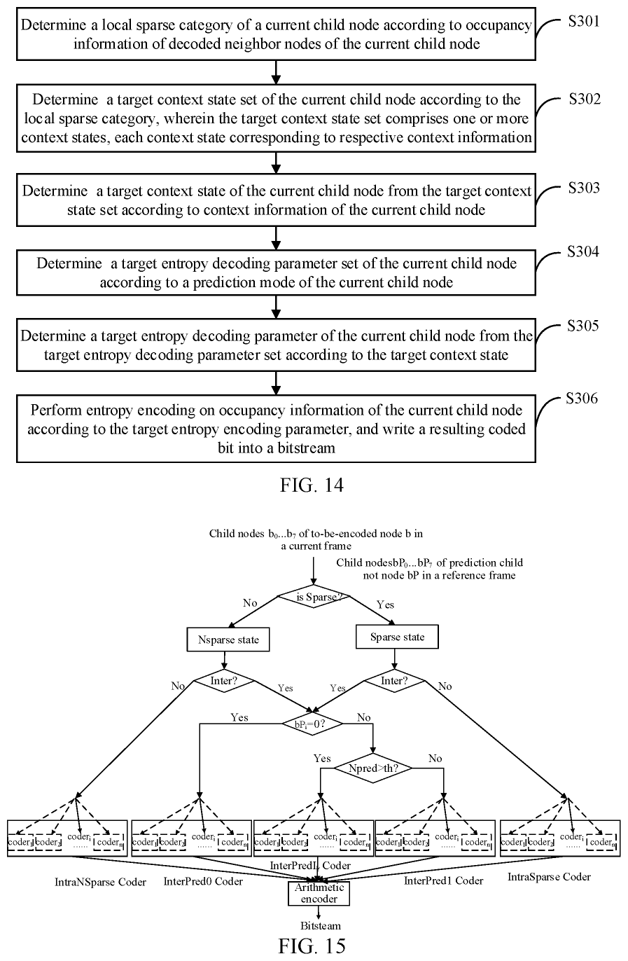

In another embodiment of This application, referring to FIG. 14, a schematic diagram of a flow of an encoding method provided in an embodiment of This application is shown. As shown in FIG. 14, the method may include:

S301: Determine a local sparse category of a current child node based on occupancy information of encoded neighbor nodes of the current child node;

It should be noted that the encoding method in the embodiment of this application is applied to a point cloud encoder. That is, the encoding method may specifically refer to a point cloud encoding method, or a point cloud entropy encoding method. More specifically, the embodiment of this application provides a point cloud encoding method based on context mapping, which reduces the number of context states, saves storage space, and improves encoding efficiency.

It should be noted that the current child node is any child node in the current node to be encoded. As shown in FIG. 7, the current node includes 8 child nodes, and the scan order of the child nodes is child node 0, child node 1, child node 2, child node 3, child node 4, child node 5, child node 6, and child node 7.

The local sparse category is used to indicate the local sparsity of the encoded neighbor nodes of the current child node. The local sparse category may include one or more sparse categories and one or more non-sparse categories. In some embodiments, determining the local sparse category of the current child node based on the occupancy information of the encoded neighbor nodes of the current child node includes: determining an occupancy count of the neighbor nodes based on the occupancy information of the neighbor nodes; determining the local sparse category of the current child node based on the occupancy count of the neighbor nodes. That is, based on the occupancy information of the neighbor nodes (i.e., whether they are occupied), the occupancy count of the neighbor nodes (i.e., the number NN of occupied neighbor nodes) can be determined, and different local sparse categories are distinguished based on the occupancy count.

Exemplarily, if the occupancy count of the neighbor nodes is greater than a second threshold, the local sparse category of the current child node is determined to be a first category; if the occupancy count of the neighbor nodes is less than or equal to the second threshold, the local sparse category of the current child node is determined to be a second category. Exemplarily, the first category may be a non-sparse category, and the second category may be a sparse category. In practical applications, more local sparse categories may be included.

In the embodiment of this application, considering the occupancy information of the encoded neighbor nodes and the position of the child node relative to the parent node, the local sparsity of the current child node is determined. Exemplarily, the neighbor nodes include at least one of the following: encoded sibling nodes of the current child node; encoded neighbor child nodes adjacent to the current child node in a first preset direction; encoded neighbor child nodes adjacent to the current child node in a second preset direction; or encoded neighbor child nodes adjacent to the current child node in a third preset direction. Here, the first preset direction may refer to the negative x-axis direction of the current child node (Left direction), the second preset direction may refer to the negative y-axis direction of the current child node (Front direction), and the third preset direction may refer to the negative z-axis direction of the current child node (Bottom direction). That is, the local sparse category may be established based on the occupancy count of the encoded neighbor nodes adjacent to the current child node in the negative x, y, z directions. It should be noted that the encoded neighbor nodes of the current child node are the same as or not completely the same as the context nodes of the current node.

Exemplarily, the local sparse category is represented as isSparse, and different values of isSparse indicate different local sparse categories. Based on the occupancy situation of the encoded neighbor nodes, the value of isSparse for the child node to be encoded is determined. Exemplarily, for the local sparse category of child node 0, it may be established based on the occupancy count (NN) of the 12 encoded child nodes adjacent to the current child node in the negative x, y, z directions as shown in FIG. 11. If the occupancy count NN>1, it is non-sparse (isSparse is 0); if the occupancy count NN≤1, it is sparse (isSparse is 1). For the local sparse category of child node 1, it may be established based on the occupancy count (NN) of the 4 encoded child nodes adjacent to the current child node in the negative y direction (Front) as shown in FIG. 11. If the occupancy count NN>0, it is determined to be a non-sparse category; if the occupancy count NN=0, it is determined to be a sparse category. For the local sparse category of child node 2, it may be established based on the occupancy count (NN) of the 4 encoded child nodes adjacent to the current child node in the negative z direction (Bottom) as shown in FIG. 11. If the occupancy count NN>0, it is determined to be a non-sparse category; if the occupancy count NN=0, it is determined to be a sparse category. For the local sparse category of child node 3, NN may be determined based on the 3 nodes bit0+bit1+bit2 together with the 4 encoded nodes in the negative x direction (Left) adjacent to the current child node as shown in FIG. 11, totaling 7 nodes. If the occupancy count NN>1, it is determined to be a non-sparse category; if the occupancy count NN≤1, it is determined to be a sparse category.

S302: Determine a target context state set of the current child node based on the local sparse category, where the target context state set includes one or more context states, and each context state corresponds to respective context information;

It should be noted that different local sparse categories correspond to different context state sets. Corresponding context state sets may be pre-configured for different local sparse categories, and then the target context state set of the current child node is determined based on the local sparse category of the current child node.

Exemplarily, when the local sparse category is a first category, the target context state set is determined to be a first context state set; when the local sparse category is a second category, the target context state set is determined to be a second context state set. In practical applications, more context state sets may be included. Here, the first context state set includes one or more context states of the first category, each context state corresponding to context information of the first category; the second context state set includes one or more context states of the second category, each context state corresponding to context information of the second category.

It should also be noted that context states and context information are in one-to-one correspondence. The context state set may include a correspondence between context information and context states, or may include a correspondence between identification information of context information and context states. The context information serves as index information in the context state set to index the corresponding context state. The context information is used to characterize the occupancy status of context nodes of the child node to be decoded, and may also be referred to as the context of the child node to be decoded. The context state is used to represent a first probability that the child node to be decoded is occupied or unoccupied under a certain context information, and may also be referred to as a probability model of the child node to be decoded. Exemplarily, when the bit length of the context information is 19 bits, there are at most 2¹⁹ context states; when the bit length of the context information is 16 bits, there are at most 2¹⁶ context states.

It should also be noted that in the embodiment of This application, it is not necessary to set different context state sets for different prediction modes. Different prediction modes may share the context state set, and the target context state set is selected only based on the local sparse category. As shown in FIG. 9, compared to the prior art which divides context states into 4 sets, including an intra non-sparse context state set (IntraNSparse state), an inter non-sparse context state set (InterNSparse state), an intra sparse context state set (IntraSparse state), and an inter sparse context set (InterSparse state), the embodiment of This application only needs to divide context states into 2 sets, including a non-sparse context state set (NSparse state) and a sparse context state set (Sparse state), significantly reducing the number of context states and saving a large amount of storage space. Additionally, in the embodiment of This application, the construction method for inter context information is exactly the same as that for intra context information, without using inter prediction information for context information construction, which also reduces the number of context states.

In some embodiments, the method further includes: constructing multiple types of context information in the context state set based on the occupancy information of the context nodes and a first construction strategy, and initializing the context state of each type of context information. Specifically, based on the occupancy information of the context nodes of the first category and the first construction strategy, multiple types of context information in the first context state set are constructed; based on the occupancy information of the context nodes of the second category and the first construction strategy, multiple types of context information in the second context state set are constructed.

S303: Determine a target context state of the current child node from the target context state set based on the context information of the current child node;

The context information of the current child node is used to represent the occupancy status of the context nodes of the current child node, and the context state is the probability of the current child node being occupied or unoccupied under the current context information. The target context state set records a context state corresponding to one or more types of context information, and the target context state of the current child node is determined by searching the target context state set using the context information of the current child node.

In some embodiments, the method further includes: determining the context information of the current child node based on the occupancy information of encoded context nodes of the current child node.

Exemplarily, the context nodes include at least one of the following: encoded sibling nodes of the current child node; encoded neighbor child nodes that are coplanar, co-edge, or co-vertex with the current child node; encoded neighbor parent nodes that are coplanar or co-edge with the current child node; other encoded neighbor nodes of the current child node. The scan order of the context nodes may be: encoded sibling nodes of the current child node>encoded coplanar child node neighbors of the current child node>encoded co-edge child node neighbors of the current child node>encoded co-vertex child node neighbors of the current child node>other encoded child node neighbors of the current child node>encoded coplanar parent node neighbors of the current child node>encoded co-edge parent node neighbors of the current child node>other encoded 20 parent node neighbors. Based on the scan order and the occupancy information, context information is constructed for the child node to be encoded.

Exemplarily, based on the occupancy information of the encoded context nodes of the current child node and the first construction strategy, the context information of the current child node is determined.

The first construction strategy is used to indicate how to generate context information based on the occupancy information of the context nodes. The first construction strategy may include: constructing context information based on a preset scan order of the context nodes and the occupancy information of the context nodes; or, constructing first information and second information of the context information based on a preset composition structure of the context information and the occupancy information of the context nodes; the bit length of the first information is fixed, and the bit length of the second information is adjustable. Here, the first information may be primary information, and the second information may be secondary information, where whether part of the information in the secondary information is used as context information is dynamically adjusted.

S304: Determine a target entropy encoding parameter set of the current child node based on a prediction mode of the current child node;

In the embodiment of this application, the prediction mode includes an intra prediction mode and an inter prediction mode, and different prediction modes correspond to different entropy encoding parameter sets. The intra prediction mode corresponds to one or more intra entropy encoding parameter sets, while the inter prediction mode corresponds to one or more inter entropy encoding parameter sets.

The target entropy encoding parameter set includes a plurality of entropy encoding parameters, and the entropy encoding parameter is a parameter used when entropy encoding occupancy information of any child node. In some embodiments, the entropy encoding parameter may be an arithmetic encoding parameter, and adaptive arithmetic encoding is performed on the occupancy information of the child node according to the arithmetic encoding parameter. Exemplarily, the arithmetic encoding parameter may be a probability that a current child node is occupied or unoccupied under current context information.

In some embodiments, a method for determining a prediction mode of a current child node may include: determining whether a current node is allowed to use an inter prediction mode according to a value of a first syntax element; when the current node is allowed to use the inter prediction mode, determining occupancy information of a prediction node of the current node in a reference frame; determining whether the inter prediction mode is used for a child node of the current node according to the occupancy information of the prediction node, where the current child node is any child node in the current node.

Whether the inter prediction mode is used for the current child node is related to the value of the first syntax element and the occupancy information of the prediction node of the current node (the parent node of the current child node). The first syntax element, as an enable flag for inter prediction, is used to indicate whether upper-layer inter prediction is enabled. In some embodiments, when the value of the first syntax element is a first value, it is determined that the current node is allowed to use the inter prediction mode; when the value of the first syntax element is a second value, it is determined that the current node is not allowed to use the inter prediction mode. Exemplarily, the first syntax element identifier at least includes a frame-level syntax element, when the value of the first syntax element is 1, inter prediction is allowed to be used; when the value of the first syntax element is 0, inter prediction is not allowed to be used.

Exemplarily, a value of the occupancy information of 0 indicates unoccupied, and a value of 1 indicates occupied. That is, when the prediction node is occupied, inter prediction is used for the current node, fully utilizing inter prediction information to improve prediction accuracy; otherwise, inter prediction is not used.

The occupancy status of the prediction node is related to the occupancy status of its child nodes. In some embodiments, the method further includes: determining occupancy information of a plurality of prediction child nodes in the prediction node; when the occupancy information of at least one prediction child node in the prediction node indicates occupied, determining that the occupancy information of the prediction node indicates occupied; otherwise, determining that the occupancy information of the prediction node indicates unoccupied. That is, if at least one child node in the prediction node is occupied, the value of its occupancy information is set to 1; otherwise, if no child node is occupied, the value of its occupancy information is set to 0.

In some embodiments, determining the target entropy encoding parameter set of the current child node according to the prediction mode of the current child node includes: when the inter prediction mode is used for the current child node, determining the target entropy encoding parameter set from candidate inter entropy encoding parameter sets, wherein the candidate inter entropy encoding parameter sets include one or more inter entropy encoding parameter sets; when the intra prediction mode is used for the current child node, determining the target entropy encoding parameter set from candidate intra entropy encoding parameter sets, wherein the candidate intra entropy encoding parameter sets include one or more intra entropy encoding parameter sets. That is, one or more entropy encoding parameter sets may be pre-configured for different inter prediction situations, and when the inter prediction mode is used, a matching target entropy encoding parameter set is selected according to the actual inter prediction situation to improve the accuracy of intra prediction. One or more entropy encoding parameter sets may also be pre-configured for different inter prediction situations, and when the intra prediction mode is used, a matching target entropy encoding parameter set is selected according to the actual intra prediction situation to improve the accuracy of intra prediction.

In some embodiments, determining the target entropy encoding parameter set from the candidate inter entropy encoding parameter sets includes: determining the target entropy encoding parameter set from the candidate inter entropy encoding parameter sets according to occupancy information of a prediction child node of the current child node in the reference frame.

The prediction child node is a co-located child node of the current child node in the prediction node, the prediction node is a prediction node of the current node in the reference frame, prediction information of the current node is determined according to the occupancy information of the prediction node, the prediction node includes a plurality of prediction child nodes, and further, prediction information of the current child node may be determined according to the occupancy information of the co-located prediction child node of the current child node. The occupancy information is also referred to as bit occupancy information or bit occupancy symbol, and the value of the occupancy information is 0 or 1, where 0 indicates unoccupied and 1 indicates occupied.

Exemplarily, determining the target entropy encoding parameter set from the candidate inter entropy encoding parameter sets according to the occupancy information of the prediction child node of the current child node in the reference frame includes: when the occupancy information of the prediction child node indicates unoccupied, determining the target entropy encoding parameter set as a first inter entropy encoding parameter set; when the occupancy information of the prediction child node indicates occupied, determining the target entropy encoding parameter set according to an occupancy intensity of the prediction child node. That is, the occupancy intensity includes one or more intensities, and when the prediction child node is occupied, the entropy encoding parameter set is further determined according to the occupancy intensity.

Exemplarily, determining the target entropy encoding parameter set according to the occupancy intensity of the prediction child node includes: when the occupancy intensity of the prediction child node is a first intensity, determining the target entropy encoding parameter set as a second inter entropy encoding parameter set; when the occupancy intensity of the prediction child node is a second intensity, determining the target entropy encoding parameter set as a third inter entropy encoding parameter set.

That is, an entropy encoding parameter set is allocated to the current child node according to the occupancy status of the prediction child node, the first entropy encoding parameter set includes a plurality of entropy encoding parameters of the current child node used when the prediction child node is unoccupied, the second entropy encoding parameter set includes a plurality of entropy encoding parameters of the current child node used when the prediction child node is occupied, and the third entropy encoding parameter set includes a plurality of entropy encoding parameters of the current child node used when the prediction child node is strongly occupied. In the embodiments of this application, for inter prediction, the entropy encoding parameter set is selected according to whether the current child node is predicted to be unoccupied, occupied, or strongly occupied, fully utilizing the correlation between inter sparse context states and non-sparse context states, thereby improving inter prediction accuracy.

Exemplarily, the occupancy intensity of the prediction child node is related to the quantity of occupied nodes in the prediction child node. Exemplarily, when the quantity of occupied nodes in the prediction child node is greater than a first threshold, the occupancy intensity is determined to be strongly occupied (i.e., the first intensity); when the quantity of occupied nodes in the prediction child node is less than or equal to the first threshold, the occupancy intensity is determined to be occupied (i.e., the second intensity).

In other embodiments, determining the target entropy encoding parameter set from the candidate inter entropy encoding parameter sets includes: determining the target entropy encoding parameter set from the candidate inter entropy encoding parameter sets according to a local sparse category.

Exemplarily, when the local sparse category is a first category, the target entropy encoding parameter set is determined as a fourth inter entropy encoding parameter set; when the local sparse category is a second category, the target entropy encoding parameter set is determined as a fifth inter entropy encoding parameter set. That is, when the inter prediction mode is used for the current child node, an inter entropy encoding parameter set may be allocated also according to the local sparse category of the current child node.

Exemplarily, determining the target entropy encoding parameter set from the candidate inter entropy encoding parameter sets may further include: determining the target entropy encoding parameter set corresponding to the target context state set according to a first mapping relationship, wherein the first mapping relationship includes a mapping relationship between one or more context state sets and inter entropy encoding parameter sets.

In some embodiments, determining the target entropy encoding parameter set from the candidate intra entropy encoding parameter sets includes: determining the target entropy encoding parameter set from the candidate intra entropy encoding parameter sets according to a local sparse category.

Exemplarily, when the local sparse category is a first category, the target entropy encoding parameter set is determined as a first intra entropy encoding parameter set; when the local sparse category is a second category, the target entropy encoding parameter set is determined as a second intra entropy encoding parameter set. That is, when the intra prediction mode is used for the current child node, an intra entropy encoding parameter set is allocated according to the local sparse category of the current child node. The first intra entropy encoding parameter set may include a plurality of entropy encoding parameters corresponding to the first category, and the second intra entropy encoding parameter set may include a plurality of entropy encoding parameters corresponding to the second category.

Exemplarily, determining the target entropy encoding parameter set from the candidate intra entropy encoding parameter sets may further include: determining the target entropy encoding parameter set corresponding to the target context state set according to a second mapping relationship, wherein the second mapping relationship includes a mapping relationship between one or more context state sets and intra entropy encoding parameter sets.

S305: Determine a target entropy encoding parameter of the current child node from the target entropy encoding parameter set according to a target context state;

One or more types of context information correspond to one context state, and the context state is used for indexing a corresponding target entropy encoding parameter. In some embodiments, determining the target entropy encoding parameter of the current child node from the target entropy encoding parameter set according to the target context state includes: determining an index value of the target entropy encoding parameter according to the target context state and a target mapping relationship; determining the target entropy encoding parameter of the current child node from the target entropy encoding parameter set according to the index value of the target entropy encoding parameter. That is, in the target entropy encoding parameter set, according to a certain mapping rule, the context state is mapped to an index value of a certain entropy encoding parameter to index the target entropy encoding parameter.

It should be noted that the mapping relationships between different context state sets and entropy encoding parameter sets may be the same or different. Exemplarily, the target mapping relationship may include: determining an index value of a target encoder according to the most significant M bits of the context state; wherein Mis related to the quantity of parameters in the target entropy encoding parameter set. Exemplarily, when the quantity N of parameters in the target entropy encoding parameter set is 32, the most significant 5 bits of the context state are taken, and the value thereof is the index value of the target entropy encoding parameter.

In some embodiments, the entropy encoding parameter may be an arithmetic encoding parameter, and adaptive arithmetic encoding is performed on the occupancy information of the child node according to the arithmetic encoding parameter. Exemplarily, the arithmetic encoding parameter may be a probability that the current child node is occupied or unoccupied under the current context information. Exemplarily, the context state is a first probability that the current child node is occupied or unoccupied under the current context information, which may also be referred to as a first probability model of the child node. The target entropy encoding parameter is a second probability that the current child node is occupied or unoccupied under the current context information, which may also be referred to as a second probability model of the child node. Therefore, the entropy encoding parameter can also be understood as a type of context state, and the entropy encoding parameter set can also be understood as a simplified set of context states.

When the bit length of the context information is 19 bits, there are at most 2¹⁹ context states; when the bit length of the context information is 16 bits, there are at most 2¹⁶ context states. The quantity of parameters in the target entropy decoding parameter set is far less than the quantity of context states. In the embodiments of this application, the target context state set has a large number of context states. If these context states are directly used for entropy encoding, the encoding efficiency is low. The target entropy encoding parameter set has a small number of entropy encoding parameters. The large number of context states in the target context state set is mapped to the small number of entropy encoding parameters in the target entropy encoding parameter set, thereby simplifying the entropy encoding parameters and improving encoding efficiency.

S306: Perform entropy encoding on the occupancy information of the current child node according to the target entropy encoding parameter, and write the obtained coded bit into a bitstream.

In some embodiments, the method further includes: updating the target entropy encoding parameter and the context state according to the occupancy information of the current child node.

Based on the above embodiments, the encoding method provided by an embodiment of this application is further illustrated by way of example. As shown in FIG. 15, the encoding method is specifically an encoding method for geometric information of a point cloud, and the method may include:

### S401: Local Sparsity Determination

The local sparsity (isSparse) of a symbol bn to be encoded is determined according to the occupancy information of encoded neighbor nodes. For example, for child node 0, the local sparsity is determined according to the occupancy count (NN) of the 12 encoded child nodes adjacent to the current child node in the negative x, y, z directions. If the occupancy count NN>1, it is non-sparse (isSparse is 0); if the occupancy count NN<=1, it is sparse (isSparse is 1).

According to the value of isSparse (0 or 1), the context states can be divided into a sparse context state set and a non-sparse context state set.

### S402: Inter Prediction Determination

whether to use inter prediction, i.e., the value of isInter2, is determined according to the occupancy information (predOcc) of the prediction node of the current node in the reference frame and the enable flag (isInter) for inter prediction.

isInter2=isInter && predOcc, i.e., the value of isInter2 is jointly determined by isInter and predOcc, where predOcc is a flag indicating whether the prediction node is occupied. Specifically, if at least one child node bPi in the prediction node is occupied, predOcc is set to 1; otherwise, if no child node is occupied, predOcc is 0. Additionally, the value of isInter is controlled by the syntax element gbh.interPredictionEnabledFlag, which is used to indicate whether upper-layer inter prediction is enabled. If enabled, it is referred to as a P-frame, and isInter is 1; otherwise, if not enabled, it is referred to as an I-frame, and isInter is 0.

### S403: Context State Selection

First, the context state set to be used is determined according to whether it is sparse (isSparse). For a non-sparse category, a non-sparse context state set (NSparse state) is used; for a sparse category, a sparse context state set (Sparse state) is used. The construction method of the context information in the non-sparse context state set and the sparse context state set may be the construction method in OBUF or the construction method of dynamic OBUF.

It should be noted that, in the existing construction method of inter context information, 2 bits of inter prediction information are added to intra context information, each type of context information corresponds to one context state, and the quantity of inter context states is four times that of intra context states, requiring a large amount of storage space. In contrast, in the embodiment of this application, construction method for the inter context may adopt the same construction method as that for the intra context, without using inter prediction information for construction, and different prediction modes may share the context state set. The target context state set is selected only based on the local sparse category, reducing the number of context states, saving a large amount of storage space, and improving decoding efficiency.

Secondly, in the selected context state set, based on the occupancy information of the context node of the child node to be encoded, the target context state of the child node to be encoded is obtained, i.e., the probability P_{S} that the child node to be encoded is occupied (or unoccupied) under this context situation.

### S404: Entropy Encoding Parameter Selection

First, for the intra prediction mode, the entropy encoding parameter set to be used is determined based on the local sparse category, which may also be referred to as a coder group. Each coder includes a corresponding entropy encoding parameter, and the entropy encoding parameter may also be understood as a type of context state. The context state set includes a large number of context states, and the coder group includes simplified context states. According to the mapping relationship between the context state set and the entropy encoding parameter set, the target entropy encoding parameter set is selected, wherein the mapping relationship may be one-to-one, one-to-many, or many-to-one.

For the inter prediction mode, the entropy encoding parameter set to be used is determined based on the occupancy information of the prediction child node. The specific method is as shown in FIG. 9.

For the inter prediction mode, if a non-sparse context state (NSparse state) is used and the prediction child node is unoccupied Pred0, it is determined to use the inter entropy encoding parameter set InterPred0 Coder; for the inter prediction mode, if the prediction child node is occupied Pred1, it is determined to use the inter entropy encoding parameter set InterPred1 Coder; for the inter prediction mode, if the prediction child node is strongly occupied PredL, it is determined to use the inter entropy encoding parameter set InterPredL Coder.

For the inter prediction mode, if a sparse context state (Sparse state) is used and the prediction child node is unoccupied Pred0, it is determined to use an inter entropy encoding parameter set InterPred0 Coder; for the inter prediction mode, if the prediction child node is occupied Pred1, it is determined to use an inter entropy encoding parameter set InterPred1 Coder; for the inter prediction mode, if the prediction child node is strongly occupied PredL, it is determined to use an inter entropy encoding parameter set InterPredL Coder.

That is, for the inter prediction mode, the sparse context state and the non-sparse context state share three entropy encoding parameter sets, and the entropy encoding parameter set is selected only based on whether being predicted as unoccupied, occupied, or strongly occupied, fully utilizing the correlation between the inter sparse context state and the inter non-sparse context state, thereby improving inter prediction accuracy.

Specifically, according to the occupancy information of the prediction child node, the information determined as inter prediction (isInter2=1) is classified into the following categories:
a) Pred0: When the prediction child node i is empty, the current child node i is predicted to be unoccupied bPi=0.
b) Pred1: When the prediction child node i is non-empty, the current child node i is predicted to be occupied bPi=1; at this time, it is further divided into two cases according to the quantity of occupied nodes (Npred) contained in the prediction child node i:
i. predL=1: When the prediction child node i is non-empty and the quantity (Npred) of occupied nodes therein exceeds a first threshold th, the current child node i is strongly occupied.
ii. predL=0: When the prediction child node i is non-empty and the quantity (Npred) of occupied nodes therein does not exceed the first threshold th, the child node i is not strongly occupied.

Secondly, in the determined coder group, the context state P_{S} of bn is mapped to the encoder Ci according to a mapping rule. The mapping rule may be taking the most significant 5 bits of the context state, the value of which is the index value of the mapped decoder, and the probability of the mapped decoder Ci is P_{C}.

### S405: Adaptive Arithmetic Coding

Using the determined probability P_{C} of the encoder Ci, adaptive arithmetic coding is performed on the occupancy information bn of the child node to be encoded.

By adopting the above technical solution, different prediction modes can share a context state set, and a target context state set is selected only according to a local sparse category, thereby reducing the number of context states and saving a large amount of storage space. For inter prediction, sparse and non-sparse context states share a decoder group, and inter prediction information is fully utilized to select a target entropy decoding parameter set, further improving the G-PCC geometry encoding efficiency.

Further, a performance test is performed on the technical solution provided by the embodiments of this application. Table 9 shows the BD-Rate representation under lossy compression of geometric information. Compared with the conventional technology, under the condition of obtaining the same encoding quality, the encoding bit rate of this application saves (BD-Rate is a negative value) or increases (BD-Rate is a positive value) by a percentage compared to the encoding bit rate of the prior art.

TABLE 9
BD-Rate for GES-TM-v3.0 lossy compression

| | Lossy geometry, lossy attributes | | | | |
|---|---|---|---|---|---|
| | End-toEnd BD- | | | Geom. BD- | |
| | AttrRate[%] | | | TotGeomRate[%] | |
| C2 | Y | U | V | D1 | D2 |
| Cat2-A average | 0.0% | 0.0% | 0.0% | −3.1187% | −3.1111% |
| Cat2-B average | 0.0% | 0.0% | 0.0% | −3.4443% | −3.5116% |
| Cat2-C average | 0.0% | 0.0% | 0.0% | −3.3445% | −3.3631% |
| Overall average | 0.0% | 0.0% | 0.0% | −3.2297% | −3.2403% |

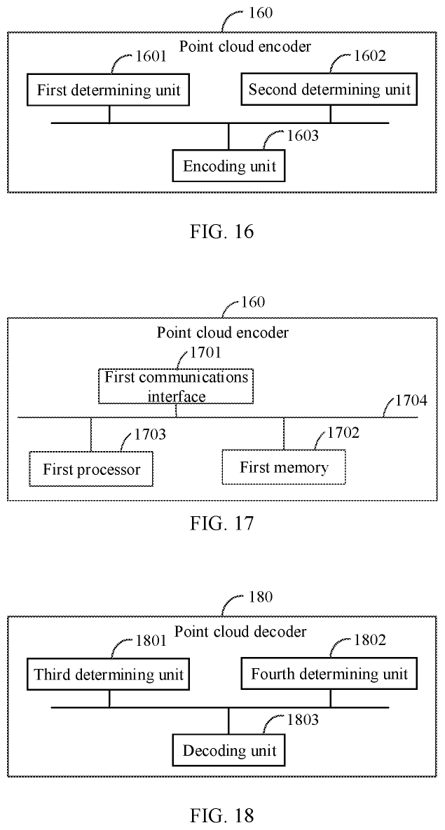

In yet another embodiment of this application, based on the same inventive concept as the previous embodiments, FIG. 16 shows a schematic diagram of the structure of a point cloud encoder provided by an embodiment of this application. As shown in FIG. 16, the point cloud encoder 160 may include: a first determining unit 1601, a second determining unit 1602, and an encoding unit 1603.

The first determining unit 1601 is configured to determine a local sparse category of a current child node based on occupancy information of encoded neighbor nodes of the current child node; and determine a target context state set of the current child node according to the local sparse category, wherein the target context state set includes one or more context states, each context state corresponding to respective context information.

The first determining unit 1601 is further configured to determine a target context state of the current child node from the target context state set according to context information of the current child node.

The second determining unit 1602 is configured to determine a target entropy encoding parameter set of the current child node according to a prediction mode of the current child node; and determine a target entropy encoding parameter of the current child node from the target entropy encoding parameter set according to the target context state.

The encoding unit 1603 is configured to perform entropy encoding on occupancy information of the current child node according to the target entropy encoding parameter, and write a resulting coded bit into a bitstream.

It may be understood that each functional unit of the point cloud encoder may also execute the encoding method of any one of the previous embodiments.

It may be understood that in the embodiments of this application, a “unit” may be a part of a circuit, a part of a processor, a part of a program or software, etc., and, it may also be a module or non-modular. Moreover, each component in this embodiment may be integrated into one processing unit, or each unit may exist physically separately, or two or more units may be integrated into one unit. The above integrated unit may be implemented in the form of hardware or in the form of software functional modules.

If the integrated unit is implemented in the form of a software functional module and is not sold or used as an independent product, it may be stored in a computer-readable storage medium. Based on such an understanding, the technical solution of this embodiment, in essence, or the part that contributes to the prior art, or all or part of the technical solution, may be embodied in the form of a software product. The computer software product is stored in a storage medium and includes several instructions for causing a computer device (which may be a personal computer, a server, or a network device, etc.) or a processor to execute all or part of the steps of the method of this embodiment. The aforementioned storage medium includes: a USB flash drive, a movable hard disk, a Read Only Memory (ROM), a Random Access Memory (RAM), a magnetic disk, a optical disk, or another media that can store program codes.

Therefore, an embodiment of this application provides a computer-readable storage medium, applied to the point cloud encoder 160. The computer-readable storage medium stores a computer program, and when the computer program is executed by a first processor, the encoding method of any one of the previous embodiments is implemented.

Based on the composition of the above point cloud encoder 160 and the computer-readable storage medium, FIG. 17 shows a schematic diagram of a specific hardware structure of the point cloud encoder 160 provided by an embodiment of this application. As shown in FIG. 17, the point cloud encoder 160 may include: a first communication interface 1701, a first memory 1702, and a first processor 1703; each component is coupled together via a first bus system 1704. It may be understood that the first bus system 1704 is used to realize connection and communication between these components. The first bus system 1704 may include, not only a data bus, but also a power bus, a control bus, and a status signal bus. However, for the sake of clarity, various buses are labeled as the first bus system 1704 in FIG. 17.

The first communication interface 1701 is configured to receive and send signals during the process of sending and receiving information with other external network elements.

The first memory 1702 is configured to store a computer program that can be run on the first processor 1703.

The first processor 1703 is configured to, when running the computer program, execute:
determining a local sparse category of a current child node based on occupancy information of encoded neighbor nodes of the current child node;
determining a target context state set of the current child node based on the local sparse category, wherein the target context state set includes one or more context states, each context state corresponding to respective context information;
determining a target context state of the current child node from the target context state set based on context information of the current child node;
determining a target entropy encoding parameter set of the current child node based on a prediction mode of the current child node;
determining a target entropy encoding parameter of the current child node from the target entropy encoding parameter set based on the target context state;
performing entropy encoding on occupancy information of the current child node based on the target entropy encoding parameter, and writing a resulting coded bit into a bitstream.

It may be understood that the first memory 1702 in the embodiments of this application may be a volatile memory or a non-volatile memory, or may include both volatile and non-volatile memories. Wherein, the non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which acts as an external cache. By way of exemplary but not a limitation, many forms of RAM are usable, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DRRAM). The first memory 1702 of the systems and methods described in this application is intended to include, but is not limited to, these and any other suitable types of memory.

The first processor 1703 may be an integrated circuit chip with signal processing capability. In the implementation process, each step of the above method may be completed by an integrated logic circuit of hardware in the first processor 1703 or instructions in the form of software. The above first processor 1703 may be a general-purpose processor, a Digital Signal Processor (DSP), an Application Specific Integrated Circuit (ASIC), a Field Programmable Gate Array (FPGA) or other programmable logic devices, discrete gate or transistor logic devices, or discrete hardware components. The methods, steps, and logic block diagrams disclosed in the embodiments of this application may be implemented or executed. The general-purpose processor may be a microprocessor or the processor may also be any conventional processor, etc. The steps of the methods disclosed in conjunction with the embodiments of this application may be directly embodied as being executed by a hardware decoding processor, or executed by a combination of hardware and software modules in the decoding processor. The software module may be located in a storage medium mature in the art, such as a random access memory, a flash memory, a read-only memory, a programmable read-only memory or an electrically erasable programmable memory, or a register. The storage medium is located in the first memory 1702, and the first processor 1703 reads information in the first memory 1702 and completes the steps of the above method in combination with its hardware.

It may be understood that the embodiments described in this application may be implemented by hardware, software, firmware, middleware, microcode, or a combination thereof. For a hardware implementation, the processing unit may be implemented in one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general-purpose processors, controllers, microcontrollers, microprocessors, other electronic units for performing the functions of this application, or a combination thereof. For a software implementation, the technology of this application may be implemented by modules (e.g., procedures, functions, etc.) that perform the functions of this application. Software codes may be stored in a memory and executed by a processor. The memory may be implemented in the processor or external to the processor.

Optionally, as another embodiment, the first processor 1703 is further configured to, when running the computer program, execute the encoding method of any one of the previous embodiments.

This embodiment provides a point cloud encoder. In the point cloud encoder, different prediction modes can share a context state set, and a target context state set is selected only according to a local sparse category, thereby reducing the number of context states and saving a large amount of storage space. Further, a larger number of context states in the target context state set are mapped to a smaller number of entropy encoding parameters in the target entropy encoding parameter set, thereby simplifying the entropy encoding parameters, reducing the bit rate, and improving the encoding efficiency.

An embodiment of this application also provides a computer-readable storage medium, which stores a bitstream generated by the encoding method of any one of the previous embodiments. The bitstream is generated by performing bit encoding on information to be encoded; wherein, the information to be encoded at least includes: occupancy information of a current child node.

In yet another embodiment of this application, based on the same inventive concept as the previous embodiments, FIG. 18 shows a schematic diagram of the structure of a point cloud decoder provided by an embodiment of this application. As shown in FIG. 18, the point cloud decoder 180 may include: a third determining unit 1801, a fourth determining unit 1802, and a decoding unit 1803.

The third determining unit 1801 is configured to determine a local sparse category of a current child node based on occupancy information of decoded neighbor nodes of the current child node; determine a target context state set of the current child node based on the local sparse category, wherein the target context state set includes one or more context states, each context state corresponding to respective context information.

The third determining unit 1801 is further configured to determine a target context state of the current child node from the target context state set based on context information of the current child node.

The fourth determining unit 1802 is configured to determine a target entropy decoding parameter set of the current child node based on a prediction mode of the current child node; determine a target entropy decoding parameter of the current child node from the target entropy decoding parameter set based on the target context state.

The decoding unit 1803 is configured to perform entropy decoding on a bitstream based on the target entropy decoding parameter to determine occupancy information of the current child node.

It may be understood that each functional unit of the point cloud decoder may also execute the decoding method of any one of the previous embodiments.

It may be understood that in this embodiment, a “unit” may be a part of a circuit, a part of a processor, a part of a program or software, etc., and of course, it may also be a module or non-modular. Moreover, each component in this embodiment may be integrated into one processing unit, or each unit may exist physically separately, or two or more units may be integrated into one unit. The above integrated unit may be implemented in the form of hardware or in the form of software functional modules.

If the integrated unit is implemented in the form of a software functional module and is not sold or used as an independent product, it may be stored in a computer-readable storage medium. Based on such an understanding, this embodiment provides a computer-readable storage medium, applied to the point cloud decoder 180. The computer-readable storage medium stores a computer program, and when the computer program is executed by a second processor, the decoding method of any one of the previous embodiments is implemented.

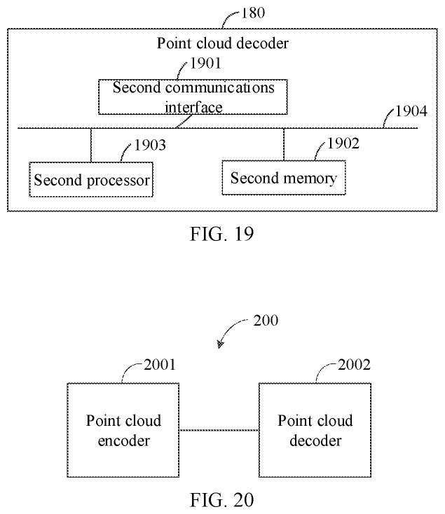

Based on the structure of the above point cloud decoder 180 and the computer-readable storage medium, FIG. 19 shows a schematic diagram of a specific hardware structure of the point cloud decoder 180 provided by an embodiment of this application. As shown in FIG. 19, the point cloud decoder 180 may include: a second communication interface 1901, a second memory 1902, and a second processor 1903; each component is coupled together via a second bus system 1904. It may be understood that the second bus system 1904 is used to realize connection and communication between these components. The second bus system 1904 may include, not only a data bus, but also a power bus, a control bus, and a status signal bus. However, for the sake of clarity, various buses are labeled as the second bus system 1904 in FIG. 19.

The second communication interface 1901 is configured to receive and send signals during the process of sending and receiving information with other external network elements.

The second memory 1902 is configured to store a computer program that can be run on the second processor 1903.

The second processor 1903 is configured to, when running the computer program, execute:
determining a local sparse category of a current child node based on occupancy information of decoded neighbor nodes of the current child node;
determining a target context state set of the current child node based on the local sparse category, wherein the target context state set includes one or more context states, each context state corresponding to respective context information;
determining a target context state of the current child node from the target context state set based on context information of the current child node;
determining a target entropy decoding parameter set of the current child node based on a prediction mode of the current child node;
determining a target entropy decoding parameter of the current child node from the target entropy decoding parameter set based on the target context state;
performing entropy decoding on a bitstream based on the target entropy decoding parameter to determine occupancy information of the current child node.

Optionally, as another embodiment, the second processor 1903 is further configured to, when running the computer program, execute the decoding method of any one of the previous embodiments.

It may be understood that the hardware functions of the second memory 1902 are similar to those of the first memory 1702, and the hardware functions of the second processor 1903 are similar to those of the first processor 1703; details are not described herein again.

This embodiment also provides a computer program product, including a computer program or instructions, which, when executed by a processor, executes the encoding method or the decoding method of any one of the previous embodiments.

This embodiment provides a point cloud decoder. In the point cloud decoder, different prediction modes can share a context state set, and a target context state set is selected only according to a local sparse category, thereby reducing the number of context states and saving a large amount of storage space. Further, a larger number of context states in the target context state set are mapped to a smaller number of entropy decoding parameters in the target entropy decoding parameter set, improving the decoding efficiency.

In another embodiment of this application, referring to FIG. 20, a schematic diagram of a structure of an encoding and decoding system provided in an embodiment of this application is shown. As shown in FIG. 20, the encoding and decoding system 200 may include a point cloud encoder 2001 and a point cloud decoder 2002.

In an embodiment of This application, the point cloud encoder 2001 may be the point cloud encoder described in any one of the foregoing embodiments, and the point cloud decoder 2002 may be the point cloud decoder described in any one of the foregoing embodiments.

It should be noted that, in This application, the terms “include”, “comprise” or any other variation thereof are intended to cover a non-exclusive inclusion, such that a process, method, article, or apparatus that includes a list of elements includes not only those elements but also other elements not expressly listed, or elements inherent to such process, method, article, or apparatus. Without further limitation, an element defined by the phrase “comprising a . . . ” does not preclude the presence of additional identical elements in the process, method, article, or apparatus that includes the element.

The serial numbers of the above embodiments of this application are used for description only and do not represent the superiority or inferiority of the embodiments.

The methods disclosed in the several method embodiments provided in this application may be arbitrarily combined as long as having no conflict, to obtain a new method embodiment. The features disclosed in the several product embodiments provided in this application may be arbitrarily combined as long as having no conflict to obtain a new product embodiment. The features disclosed in the several method or device embodiments provided in this application may be arbitrarily combined as long as having no conflict to obtain a new method embodiment or device embodiment.

The above description is only specific implementations of this application, but the protection scope of this application is not limited thereto. Any person skilled in the art can easily conceive of changes or substitutions within the technical scope disclosed in this application, which should be covered within the protection scope of this application. Therefore, the protection scope of this application shall be subject to the protection scope of the claims.

### INDUSTRIAL APPLICABILITY

In the embodiments of this application, on the encoding side or the decoding side, a target context state set of a current child node is determined according to a local sparse category of the current child node, wherein the target context state set includes one or more context states, each context state corresponding to respective context information; a target context state of the current child node is determined from the target context state set according to the context information of the current child node; a target entropy encoding/decoding parameter set of the current child node is determined according to a prediction mode of the current child node; a target entropy encoding/decoding parameter of the current child node is determined from the target entropy encoding/decoding parameter set according to the target context state; and occupancy information of the current child node is entropy encoded/decoded according to the target entropy encoding/decoding parameter. In this way, different prediction modes can share a context state set, and the target context state set is selected only according to the local sparse category, reducing the number of context states and saving a large amount of storage space. Further, a large number of context states in the target context state set are mapped to a small number of entropy encoding/decoding parameters in the target entropy encoding/decoding parameter set, improving encoding and decoding efficiency.

What is claimed is:

1. A decoding method, applied to a point cloud decoder, the method comprising:
determining a local sparse category of a current child node according to occupancy information of decoded neighbor nodes of the current child node;
determining a target context state set of the current child node according to the local sparse category, wherein the target context state set comprises one or more context states, each context state corresponding to respective context information;
determining a target context state of the current child node from the target context state set according to context information of the current child node;
determining a target entropy decoding parameter set of the current child node according to a prediction mode of the current child node;
determining a target entropy decoding parameter of the current child node from the target entropy decoding parameter set according to the target context state; and
performing entropy decoding on a bitstream according to the target entropy decoding parameter to determine occupancy information of the current child node.

2. The method according to claim 1, wherein the determining the local sparse category of the current child node according to the occupancy information of the decoded neighbor nodes of the current child node comprises:
determining an occupancy count of the neighbor nodes according to the occupancy information of the neighbor nodes; and
determining the local sparse category of the current child node according to the occupancy count of the neighbor nodes.

3. The method according to claim 1, wherein the determining the target context state set of the current child node according to the local sparse category comprises:
in response to that the local sparse category is a first category, determining the target context state set to be a first context state set; and
in response to that the local sparse category is a second category, determining the target context state set to be a second context state set.

4. The method according to claim 1, further comprising:
determining the context information of the current child node according to occupancy information of decoded context nodes of the current child node.

5. The method according to claim 1, wherein the determining the target entropy decoding parameter set of the current child node according to the prediction mode of the current child node comprises:
in response to that an inter prediction mode is used for the current child node, determining the target entropy decoding parameter set from candidate inter entropy decoding parameter sets, wherein the candidate inter entropy decoding parameter sets comprise one or more inter entropy decoding parameter sets; and
in response to that an intra prediction mode is used for the current child node, determining the target entropy decoding parameter set from candidate intra entropy decoding parameter sets, wherein the candidate intra entropy decoding parameter sets comprise one or more intra entropy decoding parameter sets.

6. The method according to claim 5, wherein the determining the target entropy decoding parameter set from the candidate inter entropy decoding parameter sets comprises: determining the target entropy decoding parameter set from the candidate inter entropy decoding parameter sets according to occupancy information of a prediction child node of the current child node in a reference frame.

7. The method according to claim 6, wherein the determining the target entropy decoding parameter set from the candidate inter entropy decoding parameter sets according to the occupancy information of the prediction child node of the current child node in the reference frame comprises:
in response to that the occupancy information of the prediction child node indicates unoccupied, determining the target entropy decoding parameter set to be a first inter entropy decoding parameter set; and
in response to that the occupancy information of the prediction child node indicates occupied, determining the target entropy decoding parameter set according to an occupancy intensity of the prediction child node, wherein different occupancy intensities correspond to different inter entropy decoding parameter sets.

8. The method according to claim 7, wherein the determining the target entropy decoding parameter set according to the occupancy intensity of the prediction child node comprises:
in response to that the occupancy intensity of the prediction child node is a first intensity, determining the target entropy decoding parameter set to be a second inter entropy decoding parameter set; and
in response to that the occupancy intensity of the prediction child node is a second intensity, determining the target entropy decoding parameter set to be a third inter entropy decoding parameter set.

9. The method according to claim 5, wherein the determining the target entropy decoding parameter set from the candidate intra entropy decoding parameter sets comprises:
determining the target entropy decoding parameter set from the candidate intra entropy decoding parameter sets according to the local sparse category.

10. The method according to claim 1, wherein the determining the target entropy decoding parameter of the current child node from the target entropy decoding parameter set according to the target context state comprises:
determining an index value of the target entropy decoding parameter according to the target context state and a target mapping relationship; and
determining the target entropy decoding parameter of the current child node from the target entropy decoding parameter set according to the index value of the target entropy decoding parameter.

11. The method according to claim 1, wherein the target context state comprises a first probability of the current child node being occupied or unoccupied under the context information, and the target entropy decoding parameter comprises a second probability of the current child node being occupied or unoccupied under the context information.

12. The method according to claim 11, wherein after performing the entropy decoding on the bitstream according to the target entropy decoding parameter to determine the occupancy information of the current child node, the method further comprises:
updating the target context state and the target entropy decoding parameter according to the occupancy information of the current child node.

13. An encoding method, applied to a point cloud encoder, the method comprising:
determining a local sparse category of a current child node according to occupancy information of encoded neighbor nodes of the current child node;
determining a target context state set of the current child node according to the local sparse category, wherein the target context state set comprises one or more context states, each context state corresponding to respective context information;
determining a target context state of the current child node from the target context state set according to context information of the current child node;
determining a target entropy encoding parameter set of the current child node according to a prediction mode of the current child node;
determining a target entropy encoding parameter of the current child node from the target entropy encoding parameter set according to the target context state; and
performing entropy encoding on occupancy information of the current child node according to the target entropy encoding parameter, and writing a resulting coded bit into a bitstream.

14. The method according to claim 13, wherein the determining the local sparse category of the current child node according to the occupancy information of the encoded neighbor nodes of the current child node comprises:
determining an occupancy count of the neighbor nodes according to the occupancy information of the neighbor nodes; and
determining the local sparse category of the current child node according to the occupancy count of the neighbor nodes.

15. The method according to claim 13, wherein the determining the target context state set of the current child node according to the local sparse category comprises:
in response to that the local sparse category is a first category, determining the target context state set to be a first context state set; and
in response to that the local sparse category is a second category, determining the target context state set to be a second context state set.

16. The method according to claim 13, further comprising:
determining the context information of the current child node according to occupancy information of encoded context nodes of the current child node.

17. The method according to claim 13, wherein the determining the target entropy encoding parameter set of the current child node according to the prediction mode of the current child node comprises:
in response to that an inter prediction mode is used for the current child node, determining the target entropy encoding parameter set from candidate inter entropy encoding parameter sets, wherein the candidate inter entropy encoding parameter sets comprise one or more inter entropy encoding parameter sets; and
in response to that an intra prediction mode is used for the current child node, determining the target entropy encoding parameter set from candidate intra entropy encoding parameter sets, wherein the candidate intra entropy encoding parameter sets comprise one or more intra entropy encoding parameter sets.

18. The method according to claim 17, wherein the determining the target entropy encoding parameter set from the candidate inter entropy encoding parameter sets comprises: determining the target entropy encoding parameter set from the candidate inter entropy encoding parameter sets according to occupancy information of a prediction child node of the current child node in a reference frame.

19. The method according to claim 18, wherein the determining the target entropy encoding parameter set from the candidate inter entropy encoding parameter sets according to the occupancy information of the prediction child node of the current child node in the reference frame comprises:
in response to that the occupancy information of the prediction child node indicates unoccupied, determining the target entropy encoding parameter set to be a first inter entropy encoding parameter set; and
in response to that the occupancy information of the prediction child node indicates occupied, determining the target entropy encoding parameter set according to an occupancy intensity of the prediction child node, wherein different occupancy intensities correspond to different inter entropy encoding parameter sets.

20. The method according to claim 17, wherein the determining the target entropy encoding parameter set from the candidate intra entropy encoding parameter sets comprises:
determining the target entropy encoding parameter set from the candidate intra entropy encoding parameter sets according to the local sparse category.
